(19) United States
(12) Patent Application Publication
(10) Pub. No.: US 2024/0168712 A1
(43) Pub. Date: May 23, 2024

(54) METHOD FOR SORTING DATA IN MULTI-CORE OR SINGLE-CORE PROCESSOR

(71) Applicant: Shanghai Cambricon Information Technology Co., Ltd, Shanghai (CN)

(72) Inventor: Xiaocheng LUO, Shanghai (CN)

(21) Appl. No.: 18/284,667

(22) PCT Filed: Jun. 24, 2022
(86) PCT No.: PCT/CN2022/100984

§ 371 Date: Sep. 28, 2023

(30) Foreign Application Priority Data
Jun. 25, 2021 (CN) 202110712924.4
Jun. 25, 2021 (CN) 202110712925.9

(51) Int. Cl. G06F 7/08; G06F 17/18

(52) U.S. Cl. CPC G06F 7/08; G06F 17/18

(57) ABSTRACT

A system for sorting data in a single-core processor and a multi-core processor is included in a combined processing apparatus. The combined processing apparatus further includes a general interconnection interface and other processing apparatus. The computing apparatus interacts with other processing apparatus to jointly complete a computing operation specified by a user. The combined processing apparatus further includes a storage apparatus. The storage apparatus is connected to the apparatus and other processing apparatus, respectively. The storage apparatus is configured to store data of the apparatus and other processing apparatus. A solution of the present disclosure improves efficiency of various operations in data processing fields including, for example, an artificial intelligence field, thus reducing overall overheads and costs of the operations.

### CROSS REFERENCE OF RELATED APPLICATIONS

This application claims benefit under 35 U.S.C. 119, 120, 121, or 365(c), and is a National Stage entry from International Application No. PCT/CN2022/100984, filed Jun. 24, 2022, which claims priority to the benefit of Chinese patent application Nos. 202110712924.4 filed on Jun. 25, 2021, and 202110712925.9 filed on Jun. 25, 2021, in the China Intellectual Property Office, the entire contents of which are incorporated herein by reference.

### BACKGROUND

### 1. Technical Field

The present disclosure relates to a computer field. More specifically, the present disclosure relates to a field of sorting data in a processor.

### 2. Background Art

Usually, artificial intelligence (AI) chips are designed for computationally intensive algorithms such as neural network algorithms, so such algorithms run efficiently on the AI chips. As such, the AI chips are not general-purpose and are therefore inefficient for general-purpose algorithms such as sorting. One method for improving the efficiency of the AI chips is to design an algorithm that fits the architecture of the AI chips, but not all general-purpose algorithms are capable of having similar solutions.

### SUMMARY

One purpose of the present disclosure is to sort data in a multi-core processor.

A first aspect of the present disclosure provides a method for sorting global data in a multi-core processor, where the multi-core processor includes a plurality of processing cores, at least two of the processing cores store local data used as part of the global data, and the method includes: creating a local digit statistical sequence, where the local digit statistical sequence includes: local general logical digits to which local existing logical digits of the same level belong in the local data, and local statistical counts of the local general logical digits in the local existing logical digits of the same level in the local data; forming a global digit statistical sequence according to the local digit statistical sequence, where the global digit statistical sequence includes: global general logical digits to which global existing logical digits of the same level belong in the global data, and global statistical counts of the global general logical digits in the global existing logical digits of the same level in the global data; determining a prefix sum of the global statistical counts of the global general logical digits in the global digit statistical sequence to form a global prefix sum sequence; and determining a position of the global data in storage space according to the global prefix sum sequence to sort the global data.

A second aspect of the present disclosure provides a method for sorting global data in a multi-core processor, where the multi-core processor includes a plurality of processing cores, at least two of the processing cores store local data used as part of the global data, and the method includes: sorting the global data according to primary existing global logical digits of the global data to form primary sorting global data; and iteratively re-sorting the primary sorting global data according to secondary existing global logical digits of the primary sorting global data to form re-sorting global data.

A third aspect of the present disclosure provides a method for sorting data in a single-core processor, and the method includes: creating a digit statistical sequence, where the digit statistical sequence includes: general logical digits to which existing logical digits of the same level belong in the data, and statistical counts of the general logical digits in the existing logical digits of the same level in the data; determining a prefix sum of the statistical counts of the general logical digits in the digit statistical sequence to form a prefix sum sequence; and determining a position of the data in storage space according to the prefix sum sequence to sort the data.

A fourth aspect of the present disclosure provides a method for sorting data in a single-core processor, including: sorting the data according to primary existing logical digits of the data to form primary sorting data; and iteratively re-sorting the primary sorting data according to secondary existing logical digits of the primary sorting data to form re-sorting data.

A fifth aspect of the present disclosure provides an electronic device, including: one or a plurality of processors; and a memory, on which a computer-executable instruction is stored, where when the computer-executable instruction is run by the one or the plurality of processors, the electronic device performs the method described above.

A sixth aspect of the present disclosure provides a computer-readable storage medium, including a computer-executable instruction, where when the computer-executable instruction is run by one or a plurality of processors, the method described above is performed.

The technical solution of the present disclosure provides a new sorting algorithm based on full vectorization, which may be used for implementing the fast sorting of data. Moreover, this sorting algorithm is suitable for sorting data in an AI chip/processor, improving the efficiency of data sorting in the AI chip/processor. Additionally, this sorting algorithm is also suitable for sorting data in a processor that supports a vector operation, which helps to improve the performance and efficiency of sorting.

### BRIEF DESCRIPTION OF DRAWINGS

By reading the following detailed description with reference to drawings, the above-mentioned and other objects, features and technical effects of exemplary implementations of the present disclosure will become easier to understand. In the drawings, several implementations of the present disclosure are shown in an exemplary manner rather than a restrictive manner, and the same or corresponding reference numerals indicate the same or corresponding parts.

FIG. 1 shows a schematic structural diagram of a processor applicable to the present disclosure according to an implementation of the present disclosure.

FIG. 2 shows a method for sorting global data in a multi-core processor according to an implementation of the present disclosure.

FIG. 3A shows a first local digit statistical sequence of data 7, 15, 3, and 100 in a processing core 0 based on units digits.

FIG. 3B shows a second local digit statistical sequence of data 28, 19, 30, and 70 in a processing core 1 based on units digits.

FIG. 4 shows a process of forming a global digit statistical sequence according to a first local digit statistical sequence and a second local digit statistical sequence according to an implementation of the present disclosure.

FIG. 5 describes a generation process of a prefix sum sequence using FIG. 4 as an example.

FIG. 6 shows a logical relationship between a position of data and a prefix sum sequence of the data.

FIG. 7 shows a method flowchart of determining a position of global data in storage space according to a global prefix sum sequence to sort the global data according to an implementation of the present disclosure.

FIG. 8 shows an implementation of a method flowchart shown in FIG. 7 according to an implementation of the present disclosure.

FIG. 9 shows an implementation of a method flowchart shown in FIG. 7 according to another implementation of the present disclosure.

FIG. 10 shows an implementation of a method flowchart shown in FIG. 7 according to another implementation of the present disclosure.

FIG. 11 shows a method flowchart of sorting data in a multi-core processor according to another implementation of the present disclosure.

FIG. 12 shows a flow diagram of iteratively re-sorting primary sorting global data according to secondary existing global logical digits of the primary sorting global data to form re-sorting global data.

FIG. 13A shows a third local digit statistical sequence of data 100, 30, 70, and 3 in a processing core 0 based on tens digits.

FIG. 13B shows a fourth local digit statistical sequence of data 15, 7, 28, and 19 in a processing core 1 based on tens digits.

FIG. 14 shows a process of forming a global digit statistical sequence according to a third local digit statistical sequence and a fourth local digit statistical sequence according to an implementation of the present disclosure.

FIG. 15 describes a generation process of a prefix sum sequence based on tens digits using FIG. 14 as an example.

FIG. 16 shows a schematic diagram of determining a position of each piece of data according to a prefix sum sequence according to another implementation of the present disclosure.

FIG. 17 shows a combined processing apparatus.

FIG. 18 shows an exemplary board card.

FIG. 19 shows a method for sorting data in a single-core processor according to an implementation of the present disclosure.

FIG. 20 shows an example of a digit statistical sequence according to an implementation of the present disclosure.

FIG. 21 describes a generation process of a prefix sum sequence using FIG. 20 as an example.

FIG. 22 shows a logical relationship between a position of data and a digit statistical sequence of the data.

FIG. 23 shows a method flowchart of determining a position of data in storage space according to a prefix sum sequence according to an implementation of the present disclosure.

FIG. 24 describes a sorting sequence shown in FIG. 23.

FIG. 25 shows a method for sorting data in a single-core processor according to another implementation of the present disclosure.

FIG. 26 shows a flow diagram of iteratively re-sorting primary sorting data according to secondary existing logical digits of the primary sorting data to form re-sorting data.

FIG. 27 shows a process of creating a prefix sum sequence based on secondary existing logical digits of data.

FIG. 28 shows a schematic diagram of determining a position of each piece of data according to a prefix sum sequence according to another implementation of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” that appear in the claims, the specification, and the drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that terms used in the specification of the present disclosure are merely intended to describe a specific embodiment rather than to limit the present disclosure. As being used in the specification and the claims of the present disclosure, unless the context clearly indicates otherwise, singular forms such as “a”, “an” and “the” are intended to include plural forms. It should also be understood that a term “and/or” used in the specification and the claims refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

For conventional algorithms for sorting data, AI chips have low computing efficiency because such algorithms are essentially difficult to be vectorized, which requires new algorithm designs.

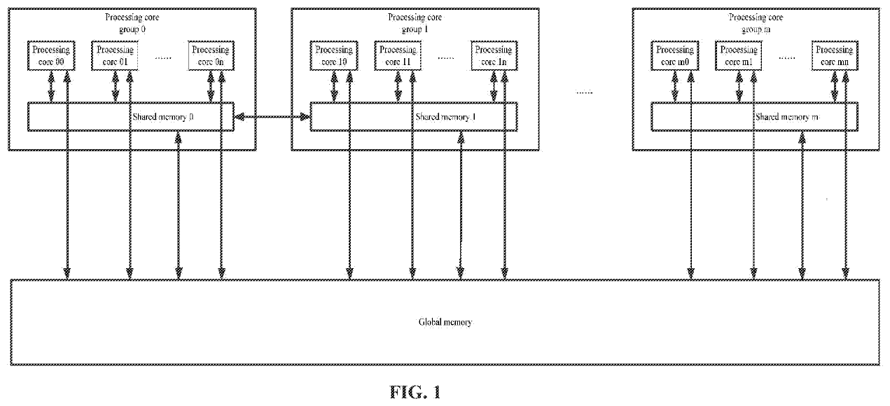

FIG. 1 shows a schematic structural diagram of a processor applicable to the present disclosure according to an implementation of the present disclosure.

The technical solution of the present disclosure may be applied to either a multi-core processor or a single-core processor. The structure of the single-core processor is relatively simple and will not be described in detail. A multi-core processor, as shown in FIG. 1, may include a plurality of processing cores, and the plurality of processing cores may further constitute a plurality of processing core groups. For example, as shown in FIG. 1, a processing core 00, a processing core 01 . . . a processing core 0n constitute a processing core group 0, and the processing core 00, the processing core 01 . . . the processing core 0n access a shared memory 0; a processing core 10, a processing core 11 . . . a processing core 1n constitute a processing core group 1, and the processing core 10, the processing core 11 . . . the processing core 1n access a shared memory 1; a processing core m0, a processing core m1 . . . a processing core mn constitute a processing core group m, and the processing core m0, the processing core m1 . . . the processing core mn access a shared memory m.

The shared memory 0˜the shared memory m of the processing core groups may communicate, and each processing core may access a global memory directly or indirectly through its corresponding shared memory.

When sorting data, the processing core may write the data to the shared memory and/or the global memory, and read the sorted data from the shared memory and/or the global memory after sorting.

For the sorting of data, there are various application scenarios. For example, decimal data may be sorted, hexadecimal data may be sorted, and binary data may be sorted. For example, for Chinese characters, the Chinese characters may be converted to ASCII codes, and then the ASCII codes are sorted according to decimal or hexadecimal data corresponding to the converted ASCII codes. More specifically, according to the technical solution of the present disclosure, single-digit data may be sorted, such as 1, 9, 7, 8, 2, and the like, and multi-digit data may also be sorted, such as 10, 24, 31, 105, 78, and the like. The technical solution of the present disclosure may also sort existing logical digits of another level in response to a case where existing logical digits of the same level in the existing logical digits are identical. Data with some identical digits are sorted directly, thereby saving sorting time, such as 10, 20, 40, 70, 90, and the like. These more specific application scenarios are described in more detail below.

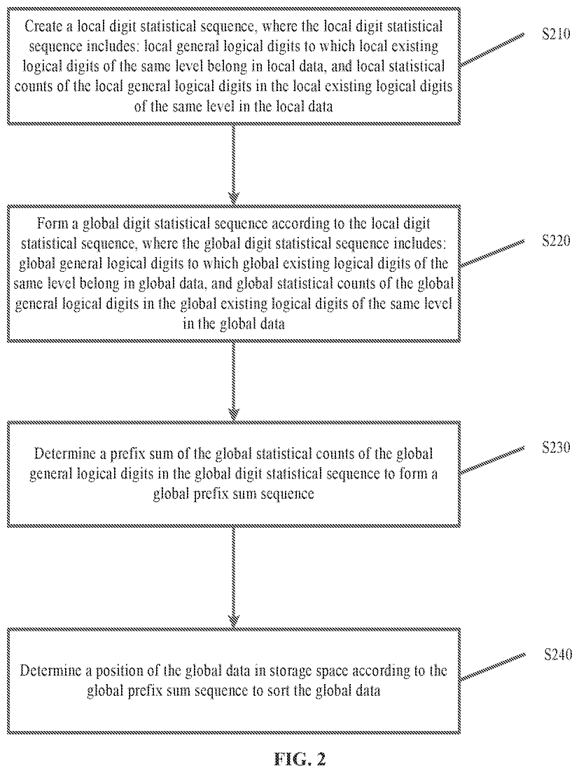

FIG. 2 shows a method for sorting global data in a multi-core processor according to an implementation of the present disclosure, where the multi-core processor includes a plurality of processing cores, at least two of the processing cores store local data used as part of the global data, and the method includes: in an operation S210, creating a local digit statistical sequence, where the local digit statistical sequence includes: local general logical digits to which local existing logical digits of the same level belong in the local data, and local statistical counts of the local general logical digits in the local existing logical digits of the same level in the local data; in an operation S220, forming a global digit statistical sequence according to the local digit statistical sequence, where the global digit statistical sequence includes: global general logical digits to which global existing logical digits of the same level belong in the global data, and global statistical counts of the global general logical digits in the global existing logical digits of the same level in the global data; in an operation S230, determining a prefix sum of the global statistical counts of the global general logical digits in the global digit statistical sequence to form a global prefix sum sequence; and in an operation S240, determining a position of the global data in storage space according to the global prefix sum sequence to sort the global data.

Firstly, concepts covered in FIG. 2 are explained.

The “data” mentioned above includes numbers and various other letters, symbols, strings, Chinese characters, and the like, that may be converted into numbers.

The “digits” mentioned above are “bits” of the data. For example, data 12 contains a digit 2 in the units place and a digit 1 in the tens place; data 108 contains a digit 8 in the units place, a digit 0 in the tens place, and a digit 1 in the hundreds place; and for example, data 5 contains a digit 5 in the units place, but may also be regarded as containing a digit 0 in the tens place, a digit 0 in the hundreds place, and so on.

The term “same level” mentioned above refers to digits in the same place in different data. For example, for data 18 and data 34, corresponding digits of the same level are 8 and 4 (units digits) and 1 and 3 (tens digits), respectively. For data 8 and data 34, corresponding digits of the same level are 8 and 4 (units digits) and 0 and 3 (tens digits), respectively.

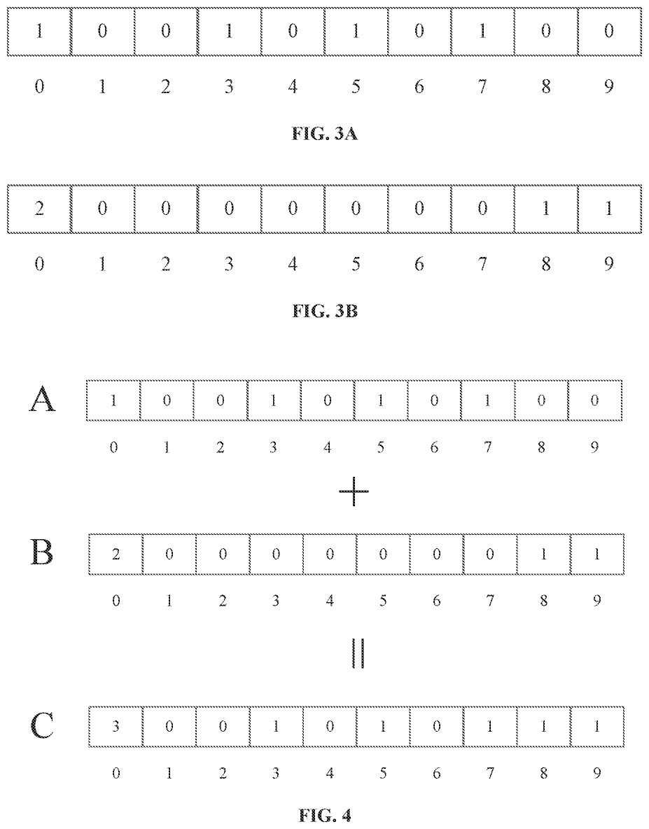

A process of creating the digit statistical sequence is explained in combination with specific examples below. FIG. 3A and FIG. 3B show schematic diagrams of an exemplary digit statistical sequence.

A logical digit refers to any form of representation of the digit of data. For decimal integers, digits are intuitive. For example, for an integer 123, the integer has three digits, including a hundreds digit 1, a tens digit 2, and a units digit 3, respectively. However, for floating-point numbers, digits are not intuitive. For example, for a floating-point number 3715.0, a corresponding hexadecimal representation is E83, so its logical digits may be E, 8, and 3.

Existing logical digits refers to digits actually contained in the data. For example, existing logical digits of the integer 123 are a hundreds digit 1, a tens digit 2, and a units digit 3, respectively; and existing logical digits of the floating-point number 3715.0 are E, 8, and 3.

The existing logical digits belong to a large logical digit collection, which is called “global logical digit” in the present disclosure. For example, general logical digits to which the existing logical digits 1, 2, and 3 of the decimal integer belong are 0˜9; and general logical digits to which the existing logical digits E, 8, and 3 of the hexadecimal representation belong are 0-F.

According to another implementation of the present disclosure, according to upper and lower limits of logical digits contained in the data participating in the sorting, the range of the general logical digits mentioned above may be the range limited by the upper and lower limits of the logical digits. For example, if the lower limit of the logical digits contained in the data participating in the sorting is 2, and the upper limit is 7, then the range of the general logical digits may be 2˜7. Of course, it may be understood that this is just a special example, and in practice, the range corresponding to the base may be selected as the range of the general logical digits.

Additionally, terms “local” and “global” mentioned above are relative concepts. For example, for a processing core group, data in each processing core may be called “local data”, and data of a plurality of processing cores in the processing core group may constitute “global data”. In another implementation, for a processor that includes a plurality of processing core groups, data in each processing core may be called “local data”, and data in the entire processor may be called “global data”. In another implementation, for a processor that includes a plurality of processing core groups, data in each processing core group may be called “local data”, and data in the entire processor may be called “global data”. As may be seen from the processor structure shown in FIG. 1, shared memories in each processing core may communicate with each other, so that a plurality of pieces of local data may communicate with each other through the shared memories and then may be combined to form global data; or data in the processing cores may be directly or indirectly stored in the global memory, so that the plurality of pieces of local data may also directly or indirectly communicate with each other through the global memory and then may be combined to form the global data. In other words, the local data is data that is accessible to only a certain processing core or processing core group, and the global data is data that is accessible to a plurality of processing cores or processing core groups. It is also required to be understood that the “data” is a broad concept, which covers any number, data set, sequence, matrix, variable, symbol, character, and so on, that the processing core processes.

Assuming that there are eight pieces of data, and these eight pieces of data are stored in two processing cores respectively, such as 7, 15, 3, 100, 28, 19, 30, and 70, where the data 7, 15, 3, and 100 are stored in a processing core 0, and the data 28, 19, 30, and 70 are stored in a processing core 1. The data 7, 15, 3, and 100 may be called the local data, and the data 7, 15, 3, 100, 28, 19, 30, and 70 may be called the global data.

These eight pieces of data 7, 15, 3, 100, 28, 19, 30, and 70 are required to be sorted based on units digits, and then, the number of each logical digit in the units place in these eight pieces of data may be counted. According to common cognition and “intuitive” judgment of human beings, if these pieces of data 7, 15, 3, 100, 28, 19, 30, and 70 are sorted from small to large based on units digits, the actual sequence of these pieces of data may be 100, 30, 70, 3, 15, 7, 28, and 19. It is required to be understood that if these pieces of data are sorted based on units digits, these three pieces of data 100, 30, and 70 may be sorted as 30, 70, and 100; these three pieces of data 100, 30, and 70 may be sorted as 70, 30, and 100; these three pieces of data 100, 30, and 70 may be sorted as 30, 100, and 70; or these three pieces of data 100, 30, and 70 may be sorted as 70, 100, and 30, and so on.

According to an implementation of the present disclosure, for data in each processing core, a digit statistical sequence may be created. The digit statistical sequence created for the data in each processing core may be called a local digit statistical sequence.

FIG. 3A shows a first local digit statistical sequence of data 7, 15, 3, and 100 in a processing core 0 based on units digits. FIG. 3B shows a second local digit statistical sequence of data 28, 19, 30, and 70 in a processing core 1 based on units digits.

As shown in FIG. 3A, in the first local digit statistical sequence, local existing logical digits of the data 7, 15, 3, and 100 in the units place are 7, 5, 3 and 0, respectively; and general logical digits to which the local existing logical digits belong are 0-9. Therefore, in the first local digit statistical sequence, a statistical count of a digit 0 is 1, a statistical count of a digit 1 is 0, a statistical count of a digit 2 is 0, a statistical count of a digit 3 is 1, a statistical count of a digit 4 is 0, a statistical count of a digit 5 is 1, a statistical count of a digit 6 is 0, a statistical count of a digit 7 is 1, a statistical count of a digit 8 is 0, and a statistical count of a digit 9 is 0.

As shown in FIG. 3B, in the second local digit statistical sequence, local existing logical digits of the data 28, 19, 30, and 70 in the units place are 8, 9, 0, and 0, respectively; and general logical digits to which the local existing logical digits belong are 0-9. Therefore, in the second local digit statistical sequence, a statistical count of a digit 0 is 2, a statistical count of a digit 1 is 0, a statistical count of a digit 2 is 0, a statistical count of a digit 3 is 0, a statistical count of a digit 4 is 0, a statistical count of a digit 5 is 0, a statistical count of a digit 6 is 0, a statistical count of a digit 7 is 0, a statistical count of a digit 8 is 1, and a statistical count of a digit 9 is 1.

The creation of the first local digit statistical sequence and the second local digit statistical sequence may be executed by each processing core in parallel to improve operation efficiency. According to another implementation of the present disclosure, a single processing core may be dedicated to forming the local digit statistical sequence. For example, the single processing core that is responsible for forming the local digit statistical sequence may access data through the shared memory to form the corresponding digit statistical sequence.

Although the statistical counts shown in FIG. 3A and FIG. 3B are arranged in the ascending order of the general logical digits 0˜9, those skilled in the art may also arrange the statistical counts in the descending order of the general logical digits 9˜0. Different arrangements will result in different positions of each piece of data, which will be described later. It is required to be understood that there is no limit to how the general logical digits are arranged.

When the first local digit statistical sequence and the second local digit statistical sequence shown in FIG. 3A and FIG. 3B are obtained, a global digit statistical sequence may be computed according to the first local digit statistical sequence and the second local digit statistical sequence obtained.

FIG. 4 shows a process of forming a global digit statistical sequence according to a first local digit statistical sequence and a second local digit statistical sequence according to an implementation of the present disclosure.

The first local digit statistical sequence is set as A, and the second local digit statistical sequence is set as B, and then the global digit statistical sequence is C=A+B. In other words, according to an implementation of the present disclosure, a plurality of local digit statistical sequences may be added accordingly to form the global digit statistical sequence.

As shown in FIG. 4, in the global digit statistical sequence, existing logical digits of data 7, 15, 3, 100, 28, 19, 30, and 70 in the units digits are 7, 5, 3, 0, 8, 9, 0, and 0, respectively; and general logical digits to which the local existing logical digits belong are 0-9. Therefore, in the global digit statistical sequence, a statistical count of a digit 0 is 3, a statistical count of a digit 1 is 0, a statistical count of a digit 2 is 0, a statistical count of a digit 3 is 1, a statistical count of a digit 4 is 0, a statistical count of a digit 5 is 1, a statistical count of a digit 6 is 0, a statistical count of a digit 7 is 1, a statistical count of a digit 8 is 1, and a statistical count of a digit 9 is 1.

It is required to be understood that although only the first local digit statistical sequence and the second local digit statistical sequence are taken as examples for explanation in the above, the present disclosure does not limit the number of the local digit statistical sequences, and for a multi-core processor, each processing core may store and process corresponding data.

According to an implementation of the present disclosure, the plurality of processing cores are connected to shared memories and communicate through the shared memories, thereby forming the global digit statistical sequence according to the local digit statistical sequence.

In this implementation, as shown in FIG. 1, a processing core 00, a processing core 01 . . . a processing core 0n constitute a processing core group 0, and the processing core 00, the processing core 01 . . . the processing core 0n access a shared memory 0; a processing core 10, a processing core 11 . . . a processing core 1n constitute a processing core group 1, and the processing core 10, the processing core 11 . . . the processing core 1n access a shared memory 1; a processing core m0, a processing core m1 . . . a processing core mn constitute a processing core group m, and the processing core m0, the processing core m1 . . . the processing core mn access a shared memory m. Thus, data in different processing cores may communicate through the shared memories and perform additional operations. More specifically, local digit statistical sequences in different processing cores may communicate through the shared memories and may be added accordingly to obtain a corresponding global digit statistical sequence.

According to another implementation of the present disclosure, the plurality of processing cores are divided into a plurality of processing core groups. In each processing core group, processing cores of the same group are connected to a shared memory. The plurality of processing core groups may communicate through respective shared memories. Thus, the global digit statistical sequence is formed according to the local digit statistical sequences.

According to another implementation of the present disclosure, the multi-core processor may include a global memory, and the plurality of processing cores are directly connected to the global memory, or the plurality of processing cores are indirectly connected to the global memory through the shared memories, thereby forming the global digit statistical sequence according to the local digit statistical sequence.

Therefore, local data may be formed into global data in a number of ways. For example, different processing cores in the same processing core group may communicate through the same shared memory, so that the local data in different processing cores may communicate through the same shared memory to form the global data; or different processing cores in different processing core groups may communicate with each other through respective shared memories, so that the local data in different processing core groups may communicate through respective shared memories to form the global data; or different processing cores or different processing core groups may communicate with each other through the global memory, so that the local data in different processing cores or different processing core groups may communicate through the global memory to form the global data.

After the digit statistical sequence shown in FIG. 4 is obtained, a prefix sum of the global digit statistical sequence may be computed. In other words, according to an implementation of the present disclosure, determining the prefix sum of the global statistical counts of the global general logical digits in the global digit statistical sequence to form a global prefix sum sequence may include: adding the global statistical counts of the global general logical digits in the global digit statistical sequence to all preceding global statistical counts to obtain a global prefix sum; and storing the global prefix sum in a corresponding position of each digit in the global general logical digits to form the global prefix sum sequence.

The prefix sum is a numeric value that reflects a position of each element. The prefix sum may be expressed by a mathematical formula as D[i]=C[0]+C[1]+ . . . C[i], or the prefix sum may be expressed as D[i]=C[i]+D[i−1]. D represents a value of each element in the prefix sum sequence, C represents a value of each element in the global digit statistical sequence mentioned above, and i represents an index of an element in the prefix sum sequence or the global digit statistical sequence.

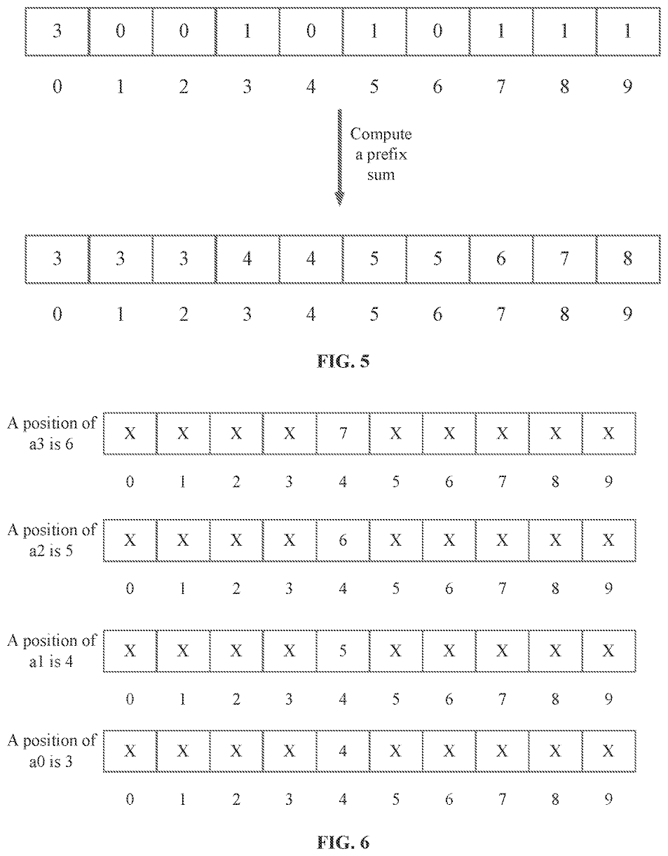

FIG. 5 describes a generation process of a prefix sum sequence using FIG. 4 as an example.

As shown in FIG. 5, a 0th element of the global digit statistical sequence is C[0]=3, so the prefix sum sequence is D[0]=C[0]=3; a 1st element of the global digit statistical sequence is C[1]=0, so the prefix sum sequence is D[1]=C[0]+C[1]=3; a 2nd element of the global digit statistical sequence is C[2]=0, so the prefix sum sequence is D[2]=C[0]+C[1]+C[2]=3; a 3rd element of the global digit statistical sequence is C[3]=1, so the prefix sum sequence is D[3]=C[0]+C[1]+C[2]+C[3]=4. Following this computing method, the global prefix sum sequence shown in FIG. 5 may be obtained.

In another implementation, the global prefix sum sequence may be computed according to D[i]=C[i]+D[i−1].

Therefore,

D[0]=C[0]=3;

D[1]=C[1]+D[0]=0+3=3;

D[2]=C[2]+D[1]=0+3=3;

D[3]=C[3]+D[2]=1+3=4;

D[4]=C[4]+D[3]=0+4=4;

D[5]=C[5]+D[4]=1+4=5;

D[6]=C[6]+D[5]=0+5=5;

D[7]=C[7]+D[6]=1+5=6;

D[8]=C[8]+D[7]=1+6=7;

D[9]=C[9]+D[8]=1+7=8.

The global digit statistical sequence may reflect the amount of data in each logical digit. For example, if a corresponding value of a digit 0 in the global digit statistical sequence is 3, it is represented that there are three pieces of data that contain the digit 0. When these three pieces of data are written to a memory, conflicts among these pieces of data are required to be avoided. In another aspect, specific positions of corresponding data may be reflected according to the prefix sum obtained through the global digit statistical sequence and the corresponding global prefix sum sequence. Thus, the position of the data in the storage space may be determined according to the global prefix sum sequence to sort the data.

FIG. 6 shows a logical relationship between a position of data and a prefix sum sequence of the data.

As shown in FIG. 6, assuming that four pieces of data a0, a1, a2, and a3 all contain a logical digit 4, and assuming that a prefix sum corresponding to the logical digit 4 is 7, a position of each piece of data that contains the logical digit may be determined based on the prefix sum 7. For clarity, a prefix sum of other logical digits is expressed as X, and a corresponding description is omitted. According to an implementation of the present disclosure, it is possible to traverse forward from the tail of the data a0, a1, a2, and a3; in other words, a position of the data a3 is 7, a position of the data a2 is 7-1, a position of the data a1 is 7-2, and a position of the data a0 is 7-3. It is also possible to traverse backward from the header of the data a0, a1, a2, and a3; in other words, the position of the data a0 is 7, the position of the data a1 is 7-1, the position of the data a2 is 7-2, and the position of the data a3 is 7-3. It is also required to be understood that a first position is considered to be 1 in the above, and if the first position is considered to be 0, then when the traversal is performed from the tail of the data a0, a1, a2, and a3, the position of the data a3 is 7-1, the position of the data a2 is 7-2, the position of the data a1 is 7-3, and the position of the data a0 is 7-4. When the traversal is performed from the header of the data a0, a1, a2, and a3, the position of the data a0 is 7-1, the position of the data a1 is 7-2, the position of the data a2 is 7-3, and the position of the data a3 is 7-4. The above difference is only in the definition of the first position, which does not affect the overall description and understanding of the technology of the present disclosure.

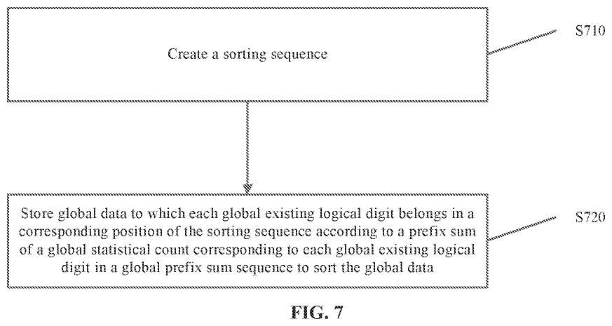

To sum up, in order to write in parallel and improve sorting efficiency, it is necessary to solve the dependence among the plurality of pieces of data mapped to the same logical digit. Therefore, positions of the plurality of pieces of data mapped to the same logical digit may be computed in advance through the prefix sum sequence to avoid conflicts when the plurality of pieces of data are written into memories or storage space. FIG. 7 shows a method flowchart of determining a position of global data in storage space according to a global prefix sum sequence to sort the global data according to an implementation of the present disclosure.

As shown in FIG. 7, determining the position of the global data in the storage space according to the global prefix sum sequence to sort the global data may include: in an operation S710, creating a sorting sequence; and in an operation S720, storing global data to which each global existing logical digit belongs in a corresponding position of the sorting sequence according to a prefix sum of a global statistical count corresponding to each global existing logical digit in the global prefix sum sequence to sort the global data.

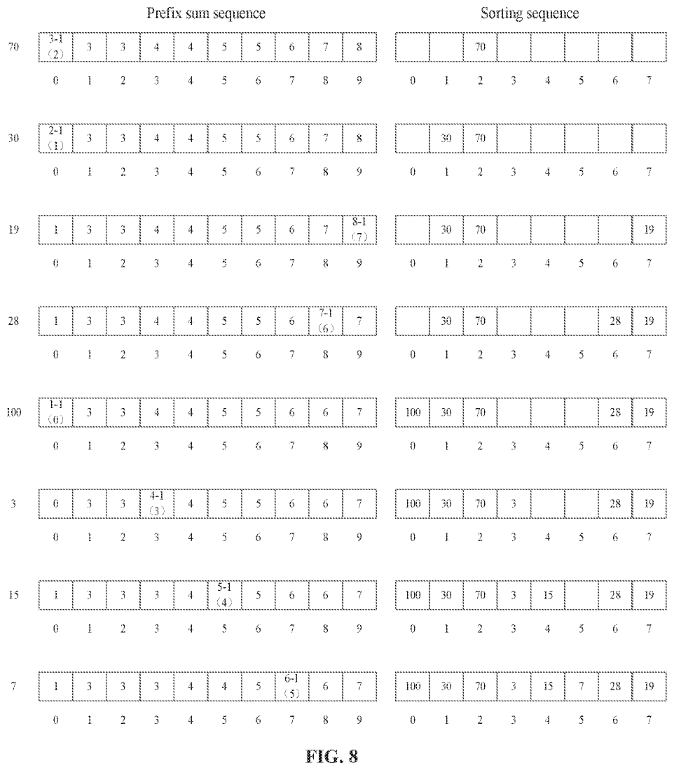

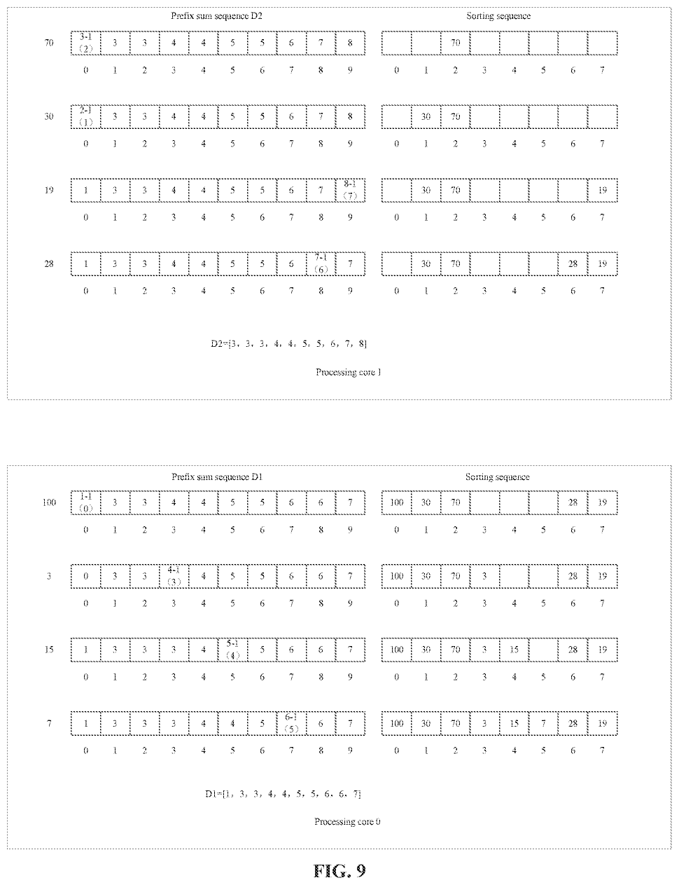

The method flowchart shown in FIG. 7 is first introduced in conjunction with FIG. 8.

As shown in FIG. 8, the sorting sequence is given, which gives position indexes 0˜9 set from low to high order. A corresponding position above each position index is used to fill corresponding data to represent the position of the data. It is required to be understood that as shown in the above, here, the first position is 0, so statistical counts in the prefix sum sequence should be subtracted by 1.

Data 7, 15, 3, 100, 28, 19, 30, and 70 are still used as examples for explanation. This sorting is still based on units digits only and does not consider the effect of tens digits.

First, as shown in FIG. 8, the traversal is performed forward from the data 70 in the tail, a prefix sum of a statistical count corresponding to a logical digit 0 in the prefix sum sequence is 3, and a corresponding position of the data 70 should be 3−1=2. Therefore, the data 70 may be filled into a position corresponding to a position index 2.

According to an implementation of the present disclosure, each time the data to which each logical digit belongs is stored in the corresponding position of the sorting sequence, the prefix sum of the statistical count corresponding to the logical digit is subtracted by 1, thereby avoiding conflicts when a plurality of pieces of data corresponding to the same logical digit are written to memories or storage space.

According to this implementation, the prefix sum corresponding to the position index 0 is subtracted by 1, so that the prefix sum becomes 2.

Next, the data 30 is traversed. At this time, a corresponding position of the data 30 should be 2−1=1. Therefore, the data 30 may be filled into a position corresponding to a position index 1. Then, the statistical count corresponding to the logical digit 0 in the prefix sum sequence may be subtracted by 1, thereby becoming 1.

Next, the data 19 is traversed, where a prefix sum of a statistical count corresponding to a logical digit 9 in the prefix sum sequence is 8, and a corresponding position of the data 19 should be 8−1=7. Therefore, the data 19 may be filled into a position corresponding to a position index 7. Additionally, the prefix sum corresponding to the logical digit 9 is subtracted by 1, so that the prefix sum becomes 7.

Next, the data 28 is traversed, where a prefix sum of a statistical count corresponding to a logical digit 8 in the prefix sum sequence is 7, and a corresponding position of the data 28 should be 7−1=6. Therefore, the data 28 may be filled into a position corresponding to a position index 6. Additionally, the prefix sum corresponding to the logical digit 8 is subtracted by 1, so that the prefix sum becomes 6.

Next, the data 100 is traversed, where a prefix sum of a statistical count corresponding to a logical digit 0 in the prefix sum sequence is 1, and a corresponding position of the data 100 should be 1−1=0. Therefore, the data 100 may be filled into a position corresponding to a position index 0. Additionally, the prefix sum corresponding to the logical digit 0 is subtracted by 1, so that the prefix sum becomes 0.

Next, the data 3 is traversed, where a prefix sum of a statistical count corresponding to a logical digit 3 in the prefix sum sequence is 4, and a corresponding position of the data 3 should be 4−1=3. Therefore, the data 3 may be filled into a position corresponding to a position index 3. Additionally, the prefix sum corresponding to the logical digit 3 is subtracted by 1, so that the prefix sum becomes 3.

Next, the data 15 is traversed, where a prefix sum of a statistical count corresponding to a logical digit 5 in the prefix sum sequence is 5, and a corresponding position of the data 15 should be 5−1=4. Therefore, the data 15 may be filled into a position corresponding to a position index 4. Additionally, the prefix sum corresponding to the logical digit 5 is subtracted by 1, so that the prefix sum becomes 4.

Next, the data 7 is traversed, where a prefix sum of a statistical count corresponding to a logical digit 7 in the prefix sum sequence is 6, and a corresponding position of the data 7 should be 6−1=5. Therefore, the data 7 may be filled into a position corresponding to a position index 5. Additionally, the prefix sum corresponding to the logical digit 7 is subtracted by 1, so that the prefix sum becomes 5.

Finally, the sorted data may be 100, 30, 70, 3, 15, 7, 28, and 19.

It is required to be understood that it is not necessary to subtract one from the prefix sum of the logical digit of the data after each piece of data is filled to the corresponding position. In another implementation, by judging in advance which logical digit corresponds to at least two pieces of data or judging in advance how much data to which each logical digit corresponds respectively, then just for a plurality of pieces of data containing the same logical digit, the prefix sum of the logical digit corresponding to the data may be subtracted by 1 after the data is filled to the corresponding position.

For example, for the data 100, 30, and 70, since the units digits of the data all contain the logical digit 0, it may be judged in advance that the logical digit 0 corresponds to three pieces of data, and digits 3, 5, 7, 8, and 9 correspond to only a piece of data respectively. Therefore, when the data 100 is filled to the corresponding position, it is necessary to subtract one from the prefix sum of the logical digit corresponding to the data 100; and for the data 3, 15, 7, 28, and 19, it is not necessary to subtract one from prefix sums of logical digits corresponding to these pieces of data. However, it is required to be understood that in actual implementations, in order to simplify operations, each time a piece of data is filled to a corresponding position, a prefix sum of a logical digit corresponding to the data may be subtracted by 1. Therefore, it is not necessary to judge the amount of data corresponding to a certain logical digit in advance.

In the hardware architecture of the present disclosure, the global data may be sorted in a variety of ways.

According to an implementation of the present disclosure, the sorting sequence is a global sorting sequence, and the global sorting sequence includes positions of global existing logical digits; moreover, through a processing core, according to a prefix sum of a global statistical count corresponding to each global existing logical digit in the global prefix sum sequence, global data to which each global existing logical digit belongs is stored in a corresponding position of the sorting sequence to sort the global data.

In this implementation, the sorting sequence is a sorting sequence for the global data, so all the global data may be filled directly in the global sorting sequence. Additionally, one of these processing cores may be specified to be responsible for the formation of this global sorting sequence without the involvement of other processing cores. This has the beneficial effect of freeing up the operation ability of other processing cores and reducing the occupancy of other processing cores.

According to the instruction of this implementation, if the global data is large in size, stronger operation ability is required, and then one of these processing core groups may be specified to be responsible for the formation of this global sorting sequence without the involvement of other processing core groups. In this way, the operation ability of other processing core groups may be freed up, and the occupancy of other processing core groups may be reduced. Additionally, compared with a case where different processing core groups participate in the operation, processing cores in the same processing core group may communicate only through the same shared memory, and the communication efficiency is higher.

According to an implementation of the present disclosure, the sorting sequence is a global sorting sequence, and the global sorting sequence includes positions of global existing logical digits; moreover, the global prefix sum sequence is divided into a plurality of local prefix sum sequences, and the local prefix sum sequence includes a local prefix sum of local existing logical digits of the same level; and through a plurality of processing cores, local data to which each local existing logical digit belongs is stored in a corresponding position of the global sorting sequence in parallel according to a local prefix sum of each local existing logical digit of the same level in the local prefix sum sequence to sort the global data.

First, as with the previous implementation, in this implementation, the sorting sequence is the sorting sequence for the global data, so all the global data may be directly filled in this global sorting sequence. However, unlike the previous implementation, in this implementation, there are a plurality of local prefix sum sequences, and each local prefix sum sequence is for the local data only, rather than for the global data as above.

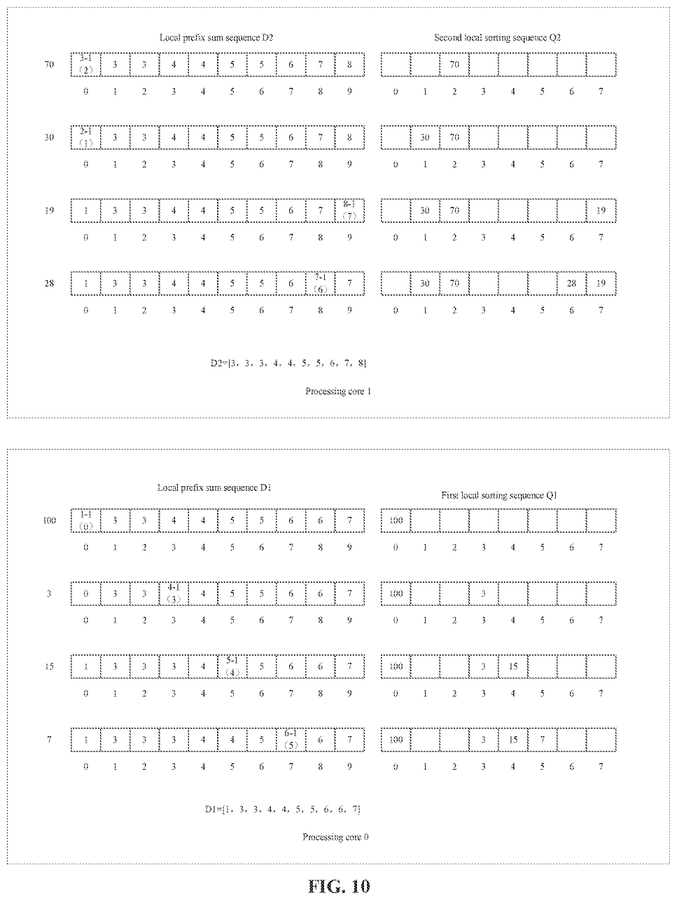

The case where there are the plurality of local prefix sum sequences is explained in combination with FIG. 9 below.

For example, as mentioned above, a first set of local data [7, 15, 3, 100] stored in a processing core 0 and a second set of local data [28, 19, 30, 70] stored in a processing core 1 are used as examples. A first local digit statistical sequence and a second local digit statistical sequence of the data are A and B, respectively. A global digit statistical sequence is C=A+B, and a global prefix sum sequence is D=[3, 3, 4, 4, 5, 5, 6, 7, 8] described above. The global prefix sum sequence represents a position of each piece of data in the sorting sequence. When the traversal is performed from the tail of the data, since there is no other data after the second set of local data [28, 19, 30, 70], a second local prefix sum sequence for units digits in the second set of local data is D2=D=[3, 3, 4, 4, 5, 5, 6, 7, 8], and a first local prefix sum sequence for units digits in the first set of local data is D1=D-B=[1, 3, 3, 4, 4, 5, 5, 6, 6, 7].

After the local prefix sum sequences D1 and D2 are obtained, according to an implementation of the present disclosure, through a plurality of processing cores, a position in which local data to which each local existing logical digit belongs should be stored is determined in parallel according to the local prefix sum sequences described above to sort the global data.

Specifically, according to this implementation, the processing core 0 may determine the position of the first set of local data [7, 15, 3, 100] according to the first local prefix sum sequence D1=[1, 3, 3, 4, 4, 5, 5, 6, 6, 7], and the processing core 1 may determine the position of the second set of local data [28, 19, 30, 70] according to the second local prefix sum sequence D2=[3, 3, 3, 4, 4, 5, 5, 6, 7, 8].

More specifically, the processing core 1 traverses forward starting with the tail data 70 in the second set of local data, where a prefix sum of a statistical count corresponding to a logical digit 0 in the prefix sum sequence is 3. A corresponding position of the data 70 should be 3−1=2. Therefore, the data 70 may be filled into a position corresponding to a position index 2.

According to this implementation, the prefix sum corresponding to the position index 0 is subtracted by 1, so that the prefix sum becomes 2.

Next, the processing core 1 traverses the data 30. At this time, a corresponding position of the data 30 should be 2−1=1. Therefore, the data 30 may be filled into a position corresponding to a position index 1. Additionally, the prefix sum corresponding to the logical digit 0 is subtracted by 1, so that the prefix sum becomes 1.

Next, the processing core 1 traverses the data 19. A prefix sum of a statistical count corresponding to a logical digit 9 in the prefix sum sequence is 8, and a corresponding position of the data 19 should be 8−1=7. Therefore, the data 19 may be filled into a position corresponding to a position index 7. Additionally, the prefix sum corresponding to the logical digit 9 is subtracted by 1, so that the prefix sum becomes 7.

Next, the processing core 1 traverses the data 28. A prefix sum of a statistical count corresponding to a logical digit 8 in the prefix sum sequence is 7, and a corresponding position of the data 28 should be 7−1=6. Therefore, the data 28 may be filled into a position corresponding to a position index 6. Additionally, the prefix sum corresponding to the logical digit 8 is subtracted by 1, so that the prefix sum becomes 6.

More specifically, the processing core 0 traverses forward starting with the tail data 100 in the first set of local data, where a prefix sum of a statistical count corresponding to a logical digit 0 in the prefix sum sequence is 1, and a corresponding position of the data 100 should be 1−1=0. Therefore, the data 100 may be filled into a position corresponding to a position index 0. Additionally, the prefix sum corresponding to the logical digit 0 is subtracted by 1, so that the prefix sum becomes 0.

Next, the processing core 0 traverses the data 3. A prefix sum of a statistical count corresponding to a logical digit 3 in the prefix sum sequence is 4, and a corresponding position of the data 3 should be 4−1=3. Therefore, the data 3 may be filled into a position corresponding to a position index 3. Additionally, the prefix sum corresponding to the logical digit 3 is subtracted by 1, so that the prefix sum becomes 3.

Next, the processing core 0 traverses the data 15. A prefix sum of a statistical count corresponding to a logical digit 5 in the prefix sum sequence is 5, and a corresponding position of the data 15 should be 5−1=4. Therefore, the data 15 may be filled into a position corresponding to a position index 4. Additionally, the prefix sum corresponding to the logical digit 5 is subtracted by 1, so that the prefix sum becomes 4.

Finally, the processing core 0 traverses the data 7. A prefix sum of a statistical count corresponding to a logical digit 7 in the prefix sum sequence is 6, and a corresponding position of the data 7 should be 6−1=5. Therefore, the data 7 may be filled into a position corresponding to a position index 5. Additionally, the prefix sum corresponding to the logical digit 7 is subtracted by 1, so that the prefix sum becomes 5.

Finally, the sorted data may be 100, 30, 70, 3, 15, 7, 28, and 19.

It is required to be understood that in the example above, although each processing core sorts its own stored data, other processing cores may also be specified to perform sort operations. It is also required to be understood that although the sorting is performed by the processing core 1 and then by processing core 0 in the example shown in FIG. 9, in practice, these two processing cores may run independently in parallel without being affected by each other.

The technical solution provided by this implementation may adopt a plurality of parallel processing cores to perform the sorting operations, which significantly improves the execution efficiency of the sorting operations.

According to another implementation of the present disclosure, the global sorting sequence may include a plurality of local sorting sequences, where the local sorting sequence includes a position of local data to which local existing logical digits belong; the global prefix sum sequence is divided into a plurality of local prefix sum sequences, and the local prefix sum sequence includes a local prefix sum of local existing logical digits of the same level; and through a plurality of processing cores, local data to which each local existing logical digit belongs is respectively stored in a corresponding position of the local sorting sequence in parallel according to a local prefix sum of each local existing logical digit of the same level in the local prefix sum sequence to sort the global data.

The difference between this implementation and the one shown in FIG. 9 is that there is one sorting sequence in the implementation of FIG. 9, and all processing cores access the same sorting sequence when sorting corresponding local data. However, in the implementation shown in FIG. 10, the sorting sequence consists of a plurality of local sorting sequences, and each processing core accesses only a corresponding local sorting sequence.

Another implementation of the present disclosure is explained in detail in combination with FIG. 10 below.

In FIG. 10, the sorting sequence includes a first local sorting sequence Q1 and a second local sorting sequence Q2, where structures of the two local sorting sequences Q1 and Q2 are similar to that of the global sorting sequence described above, and both the two local sorting sequences Q1 and Q2 include position indexes 0-7.

As mentioned above, the first set of local data [7, 15, 3, 100] stored in the processing core 0 and the second set of local data [28, 19, 30, 70] stored in the processing core 1 are still used as examples. The first local digit statistical sequence and the second local digit statistical sequence of the data are A and B, respectively. The global digit statistical sequence is C=A+B, and the global prefix sum sequence is D=[3, 3, 3, 4, 4, 5, 5, 6, 7, 8] described above. The global prefix sum sequence represents the position of each piece of data in the sorting sequence. When the traversal is performed from the tail of the data, since there is no other data after the second set of local data [28, 19, 30, 70], the second local prefix sum sequence for units digits in the second set of local data is D2=D=[3, 3, 3, 4, 4, 5, 5, 6, 7, 8], and the first local prefix sum sequence for units in the first set of local data is D1=D-B=[1, 3, 3, 4, 4, 5, 5, 6, 6, 7].

The first local sorting sequence Q1 is used to sort the first set of local data [7, 15, 3, 100], and the second local sorting sequence Q2 is used to sort the second set of local data [28, 19, 30, 70].

After the local prefix sum sequences D1 and D2 are obtained, according to an implementation of the present disclosure, through a plurality of processing cores, a position in which local data to which each local existing logical digit belongs should be stored is determined in parallel according to the local prefix sum sequences described above to sort the global data.

Specifically, according to this implementation, the processing core 0 may determine the position of the first set of local data [7, 15, 3, 100] according to the local prefix sum sequence D1=[1, 3, 3, 4, 4, 5, 5, 6, 6, 7], and the processing core 1 may determine the position of the second set of local data [28, 19, 30, 70] according to the local prefix sum sequence D2=[3, 3, 3, 4, 4, 5, 5, 6, 7, 8].

More specifically, the processing core 1 traverses forward starting with the tail data 70 in the second set of local data, where a prefix sum of a statistical count corresponding to a logical digit 0 in the prefix sum sequence is 3. A corresponding position of the data 70 should be 3−1=2. Therefore, the data 70 may be filled into a position corresponding to a position index 2 of the second local sorting sequence Q2.

According to this implementation, the prefix sum corresponding to the position index 0 is subtracted by 1, so that the prefix sum becomes 2.

Next, the processing core 1 traverses the data 30. At this time, a corresponding position of the data 30 should be 2−1=1. Therefore, the data 30 may be filled into a position corresponding to a position index 1 of the second local sorting sequence Q2. Additionally, the prefix sum corresponding to the logical digit 0 is subtracted by 1, so that the prefix sum becomes 1.

Next, the processing core 1 traverses the data 19. A prefix sum of a statistical count corresponding to a logical digit 9 in the prefix sum sequence is 8, and a corresponding position of the data 19 should be 8−1=7. Therefore, the data 19 may be filled into a position corresponding to a position index 7 of the second local sorting sequence Q2. Additionally, the prefix sum corresponding to the logical digit 9 is subtracted by 1, so that the prefix sum becomes 7.

Next, the processing core 1 traverses the data 28. A prefix sum of a statistical count corresponding to a logical digit 8 in the prefix sum sequence is 7, and a corresponding position of the data 28 should be 7−1=6. Therefore, the data 28 may be filled into a position corresponding to a position index 6 of the second local sorting sequence Q2. Additionally, the prefix sum corresponding to the logical digit 8 is subtracted by 1, so that the prefix sum becomes 6.

More specifically, the processing core 0 traverses forward starting with the tail data 100 in the first set of local data, where a prefix sum of a statistical count corresponding to a logical digit 0 in the prefix sum sequence is 1, and a corresponding position of the data 100 should be 1−1=0. Therefore, the data 100 may be filled into a position corresponding to a position index 0 of the first local sorting sequence Q1. Additionally, the prefix sum corresponding to the logical digit 0 is subtracted by 1, so that the prefix sum becomes 0.

Next, the processing core 0 traverses the data 3. A prefix sum of a statistical count corresponding to a logical digit 3 in the prefix sum sequence is 4, and a corresponding position of the data 3 should be 4−1=3. Therefore, the data 3 may be filled into a position corresponding to a position index 3 of the first local sorting sequence Q1. Additionally, the prefix sum corresponding to the logical digit 3 is subtracted by 1, so that the prefix sum becomes 3.

Next, the processing core 0 traverses the data 15. A prefix sum of a statistical count corresponding to a logical digit 5 in the prefix sum sequence is 5, and a corresponding position of the data 15 should be 5−1=4. Therefore, the data 15 may be filled into a position corresponding to a position index 4 of the first local sorting sequence Q1. Additionally, the prefix sum corresponding to the logical digit 5 is subtracted by 1, so that the prefix sum becomes 4.

Finally, the processing core 0 traverses the data 7. A prefix sum of a statistical count corresponding to a logical digit 7 in the prefix sum sequence is 6, and a corresponding position of the data 7 should be 6−1=5. Therefore, the data 7 may be filled into a position corresponding to a position index 5 of the first local sorting sequence Q1. Additionally, the prefix sum corresponding to the logical digit 7 is subtracted by 1, so that the prefix sum becomes 5.

Finally, the sorted data forms two sorting sequences; in other words, the second local sorting sequence Q2 is used for the data [30, 70, 28, 19], and the first local sorting sequence Q1 is used for the data [100, 3, 15, 7].

The plurality of local sorting sequences obtained by the above method may be combined into an overall global sorting sequence, so that the position of each piece of data may be determined according to the overall global sorting sequence. Of course, combining the plurality of local sorting sequences into the global sorting sequence is not necessary, and the position of each piece of data may also be determined according to each individual local sorting sequence.

Through the implementation shown in FIG. 10, when determining the sorting sequence of the data, each processing core (or processing core group) may determine the position of each piece of data through the individual local sorting sequence without accessing the same sorting sequence frequently, which reduces the overhead of global communication and reduces communication burdens. The technical solution provided by this implementation adopts a plurality of parallel processing cores to perform sorting operations, which significantly improves the execution efficiency of the sorting operations.

It is required to be understood that in the example above, although each processing core sorts its own stored data, other processing cores may also be specified to perform the sort operations.

After the data is sorted based on units digits, new sorting results are 100, 30, 70, 3, 15, 7, 28, and 19. According to an implementation of the present disclosure, this sorting structure may be re-stored.

An implementation of the present disclosure further includes: dividing sorted global data into a plurality of groups of sorted local data; and storing the plurality of groups of sorted local data in a plurality of processing cores respectively.

Taking the sorted global data 100, 30, 70, 3, 15, 7, 28, and 19 as examples, the data may be divided into two groups of local data, including [100, 30, 70, 3] and [15, 7, 28, 19]. The local data formed by dividing may be stored in different processing cores respectively, such as a processing core 0 and a processing core 1. Thus, the data in the processing core 0 is updated from the initial [7, 15, 3, 100] to [100, 30, 70, 3], and the data in processing core 1 is updated from the initial [28, 19, 30, 70] to [15, 7, 28, 19].

The sorting based on a certain level of logical digits (such as units digits) is described in the above, while in another embodiment, the overall data may be further sorted. For the above sequence, an expected sequence from small to large is 3, 7, 15, 19, 28, 30, 70, and 100, while the sequence after sorting based on units digits is 100, 30, 70, 3, 15, 7, 28, and 19, which obviously does not achieve the desired purpose, so it is required to further sort according to tens digits and hundreds digits.

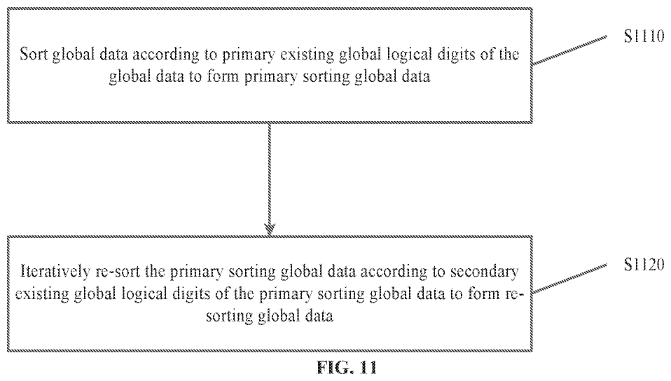

FIG. 11 shows a method for sorting data in a multi-core processor according to another implementation of the present disclosure, including: in an operation S1110, sorting global data according to primary existing global logical digits of the global data to form primary sorting global data; and in an operation S1120, iteratively re-sorting the primary sorting global data according to secondary existing global logical digits of the primary sorting global data to form re-sorting global data.

At present, no data sorting solution based on multilevel digits in the multi-core processor has been found. The technical solution of the present disclosure adopts multilevel sorting to adjust the position of the data step by step, so as to finally realize data sorting.

For the operation S1110, sorting the global data according to the primary existing global logical digits of the global data to form the primary sorting global data may include: creating a primary local digit statistical sequence, where the primary local digit statistical sequence includes: primary local general logical digits to which primary local existing logical digits belong in the local data, and primary local statistical counts of the primary local general logical digits in the primary local existing logical digits; forming a primary global digit statistical sequence according to the primary local digit statistical sequence, where the primary global digit statistical sequence includes: primary global general logical digits to which primary global existing logical digits belong in the global data, and primary global statistical counts of the primary global general logical digits in the primary global existing logical digits; determining a prefix sum of the primary global statistical counts of the primary global general logical digits in the primary global digit statistical sequence to form a primary global prefix sum sequence; and determining a primary position of the global data in storage space according to the primary global prefix sum sequence to sort the global data.

In the description above, terms “primary” and “secondary” are used to represent different bits in which logical digits are located. For example, the units digit of the data may be called “primary”, and the tens digit of the data may be called “secondary”. After the data is sorted based on the tens digit, the tens digit of the data may be called new “primary” and the hundreds digit of the data may be called new “secondary”. The above iteration operation continues until all bits are sorted.

The above has explained the operation by taking the data 7, 15, 3, 100, 28, 19, 30, and 70 as examples, and the obtained primary sorting global data may be 100, 30, 70, 3, 15, 7, 28, and 19. The primary sorting global data is sorted based on the units digits of the above global data, which will not be repeated herein.

According to an implementation of the present disclosure, after the primary sorting of the data, the primary sorting global data may be divided into a plurality of groups of primary local sorting data; and the plurality of groups of primary local sorting data are stored in the plurality of processing cores respectively. In this implementation, the data after the primary sorting is further divided into a plurality of groups of local sorting data, and the plurality of groups of local sorting data are stored to corresponding processing cores, which facilitates further sorting iteratively.

According to an implementation of the present disclosure, the primary local statistical counts are arranged in an ascending or descending order of the primary local general logical digits.

According to an implementation of the present disclosure, forming the primary global digit statistical sequence according to the primary local digit statistical sequence may include: adding a plurality of primary local digit statistical sequences accordingly to form the primary global digit statistical sequence.

According to an implementation of the present disclosure, the plurality of processing cores are connected to shared memories and communicate through the shared memories, so that the primary global digit statistical sequence is formed according to the primary local digit statistical sequence.

According to an implementation of the present disclosure, the plurality of processing cores are divided into a plurality of processing core groups. In each processing core group, processing cores of the same group are connected to a shared memory. The plurality of processing core groups communicate through respective shared memories. Thus, the primary global digit statistical sequence is formed according to the primary local digit statistical sequence.

According to an implementation of the present disclosure, the multi-core processor includes a global memory, and the plurality of processing cores are directly connected to the global memory, or the plurality of processing cores are indirectly connected to the global memory through the shared memories, thus forming the primary global digit statistical sequence according to the primary local digit statistical sequences.

According to an implementation of the present disclosure, determining the prefix sum of the primary global statistical counts of the primary global general logical digits in the primary global digit statistical sequence to form the primary global prefix sum sequence includes: adding the primary global statistical counts of the primary global general logical digits in the primary global digit statistical sequence to all preceding primary global statistical counts to obtain a primary global prefix sum; and storing the primary global prefix sum in a corresponding position of each digit in the primary global general logical digits to form the primary global prefix sum sequence.

According to an implementation of the present disclosure, determining the primary position of the global data in the storage space according to the primary global prefix sum sequence to sort the global data includes: creating a sorting sequence; and storing global data to which each primary global existing logical digit belongs in a corresponding position of the sorting sequence according to a prefix sum of a primary global statistical count corresponding to each primary global existing logical digit in the primary global prefix sum sequence to sort the global data.

According to an implementation of the present disclosure, the sorting sequence is a primary global sorting sequence, and the primary global sorting sequence includes positions of primary global existing logical digits; moreover, through a processing core, according to a prefix sum of a primary global statistical count corresponding to each primary global existing logical digit in the primary global prefix sum sequence, global data to which each primary global existing logical digit belongs is stored in a corresponding position of the sorting sequence to sort the global data.

According to an implementation of the present disclosure, the sorting sequence is a primary global sorting sequence, and the primary global sorting sequence includes positions of primary global existing logical digits; moreover, the primary global prefix sum sequence is divided into a plurality of primary local prefix sum sequences, and the primary local prefix sum sequence includes local prefix sums of primary local existing logical digits; and through a plurality of processing cores, local data to which each primary local existing logical digit belongs is stored in a corresponding position of the primary global sorting sequence in parallel according to a local prefix sum of each primary local existing logical digit in the primary local prefix sum sequence to sort the global data.

According to an implementation of the present disclosure, the primary sorting sequence includes a plurality of primary local sorting sequences, where the primary local sorting sequence includes positions of primary local existing logical digits; moreover, the primary global prefix sum sequence is divided into a plurality of primary local prefix sum sequences, and the primary local prefix sum sequence includes local prefix sums of the primary local existing logical digits; and through a plurality of processing cores, local data to which each primary local existing logical digit belongs is respectively stored in a corresponding position of the primary local sorting sequence in parallel according to a local prefix sum of each primary local existing logical digit in the primary local prefix sum sequence to sort the global data.

An implementation of the present disclosure further includes: each time global data to which each primary global existing logical digit belongs or local data to which each local existing logical digit belongs is stored in a corresponding position of the sorting sequence, subtracting one from the prefix sum of the global statistical count or the local prefix sum.

An implementation of the present disclosure further includes: sorting existing global logical digits of another level of the global data in response to a case where all existing global logical digits of the same level in the global data are identical.

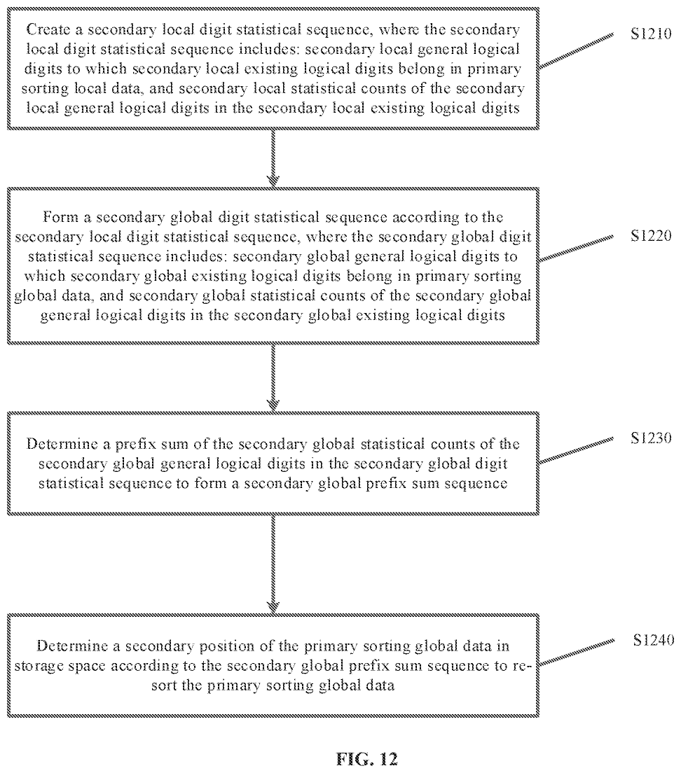

FIG. 12 shows a flow diagram of iteratively re-sorting primary sorting global data according to secondary existing global logical digits of the primary sorting global data to form re-sorting global data.

In this implementation, at least two of the processing cores store primary sorting local data used as part of the primary sorting global data, and iteratively re-sorting the primary sorting global data according to the secondary existing global logical digits of the primary sorting global data to form the re-sorting global data includes: in an operation S1210, creating a secondary local digit statistical sequence, where the secondary local digit statistical sequence includes: secondary local general logical digits to which secondary local existing logical digits belong in the primary sorting local data, and secondary local statistical counts of the secondary general logical digits in the secondary local existing logical digits; in an operation S1220, forming a secondary global digit statistical sequence according to the secondary local digit statistical sequence, where the secondary global digit statistical sequence includes: secondary global general logical digits to which secondary global existing logical digits belong in the primary sorting global data, and secondary global statistical counts of the secondary global general logical digits in the secondary global existing logical digits; in an operation S1230, determining a prefix sum of the secondary global statistical counts of the secondary global general logical digits in the secondary global digit statistical sequence to form a secondary global prefix sum sequence; and in an operation S1240, determining a secondary position of the primary sorting global data in storage space according to the secondary global prefix sum sequence to re-sort the primary sorting global data.

The data after the primary sorting may be further sorted based on the tens place. After the data is further sorted based on the tens place of the data, the data may be sorted based on the hundreds place of the data.

It may be understood that for primary sorting global data 100, 30, 70, 3, 15, 7, 28, and 19, the primary sorting global data 100, 30, 70, and 3 is stored in a processing core 0, and the primary sorting global data 15, 7, 28, and 19 is stored in a processing core 1.

If these eight pieces of data 100, 30, 70, 3, 15, 7, 28, and 19 are required to be sorted based on the tens place, then the number of each logical digit in the units place in these eight pieces of data may be counted.

Similarly, a digit statistical sequence may be created for primary sorting local data in each processing core. The digit statistical sequence created for the primary sorting local data in each processing core may also be called a local digit statistical sequence.

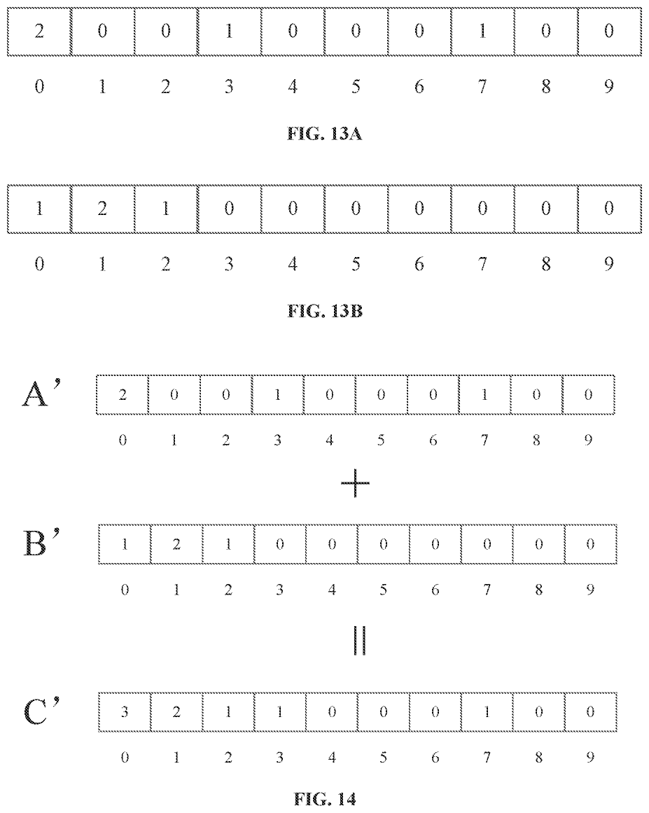

FIG. 13A shows a third local digit statistical sequence of data 100, 30, 70, and 3 in a processing core 0 based on tens digits. FIG. 13B shows a fourth local digit statistical sequence of data 15, 7, 28, and 19 in a processing core 1 based on tens digits.

As shown in FIG. 13A, in the third local digit statistical sequence, local existing logical digits of the data 100, 30, 70, and 3 in the tens place are 0, 3, 7, and 0, respectively; and general logical digits to which the local existing logical digits belong are 0-9. Therefore, in the third local digit statistical sequence, a statistical count of a digit 0 is 2, a statistical count of a digit 1 is 0, a statistical count of a digit 2 is 0, a statistical count of a digit 3 is 1, a statistical count of a digit 4 is 0, a statistical count of a digit 5 is 0, a statistical count of a digit 6 is 0, a statistical count of a digit 7 is 1, a statistical count of a digit 8 is 0, and a statistical count of a digit 9 is 0.

As shown in FIG. 13B, in the fourth local digit statistical sequence, local existing logical digits of the data 15, 7, 28, and 19 in the tens place are 1, 0, 2, and 1, respectively; and general logical digits to which the local existing logical digits belong are 0-9. Therefore, in the fourth local digit statistical sequence, a statistical count of a digit 0 is 1, a statistical count of a digit 1 is 2, a statistical count of a digit 2 is 1, a statistical count of a digit 3 is 0, a statistical count of a digit 4 is 0, a statistical count of a digit 5 is 0, a statistical count of a digit 6 is 0, a statistical count of a digit 7 is 0, a statistical count of a digit 8 is 0, and a statistical count of a digit 9 is 0.

The creation of the third local digit statistical sequence and the fourth local digit statistical sequence may be executed by each processing core in parallel to improve operation or sorting efficiency. According to another implementation of the present disclosure, a single processing core may be dedicated to forming local digit statistical sequences. For example, the single processing core that is responsible for forming the local digit statistical sequences may access data through shared memories and/or global memories to form corresponding digit statistical sequences.

Although the statistical counts shown in FIG. 13A and FIG. 13B are arranged in the ascending order of the general logical digits 0-9, those skilled in the art may also arrange the statistical counts in the descending order of the general logical digits 9-0. Different arrangements will result in different positions of each piece of data, which has been described above and will not be repeated here.

When the third local digit statistical sequence shown in FIG. 13A and the fourth local digit statistical sequence shown in FIG. 13B are obtained, the global digit statistical sequence may be computed according to the third local digit statistical sequence and the fourth local digit statistical sequence obtained.

FIG. 14 shows a process of forming a global digit statistical sequence according to a third local digit statistical sequence and a fourth local digit statistical sequence according to an implementation of the present disclosure.

The third local digit statistical sequence is set as A′, and the fourth local digit statistical sequence is set as B′, and then the global digit statistical sequence is C′=A′+B′. Similarly, a plurality of local digit statistical sequences may be added accordingly to form the global digit statistical sequence.

As shown in FIG. 14, in the global digit statistical sequence, existing logical digits of data 100, 30, 70, 3, 15, 7, 28, and 19 in the tens place are 0, 3, 7, 0, 1, 0, 2, and 1, respectively; and general logical digits to which the existing logical digits belong are 0-9. Therefore, in the global digit statistical sequence, a statistical count of a digit 0 is 3, a statistical count of a digit 1 is 2, a statistical count of a digit 2 is 1, a statistical count of a digit 3 is 1, a statistical count of a digit 4 is 0, a statistical count of a digit 5 is 0, a statistical count of a digit 6 is 0, a statistical count of a digit 7 is 1, a statistical count of a digit 8 is 0, and a statistical count of a digit 9 is 0.

When the digit statistical sequence shown in FIG. 14 is obtained, a prefix sum of the global digit statistical sequence may be computed.

As mentioned above, the prefix sum may be expressed by a mathematical formula as D′[i]=C′[0]+C′[1]+ . . . C′[i], or the prefix sum may be expressed as D′[i]=C′[i]+D′[i−1].

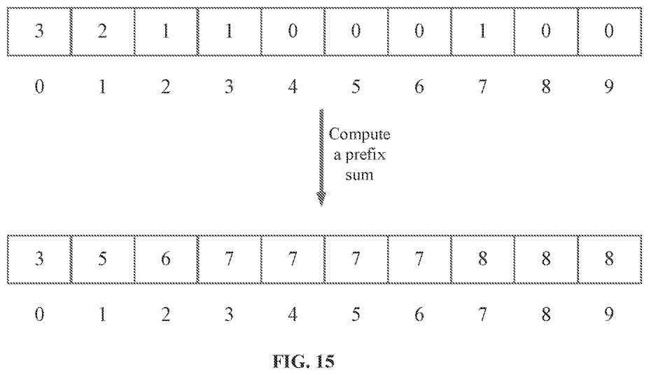

FIG. 15 describes a generation process of a prefix sum sequence based on tens digits using FIG. 14 as an example.

As shown in FIG. 15, a 0th element of the global digit statistical sequence is C′[0]=3, so the prefix sum sequence is D′[0]=C′[0]=3; a 1st element of the global digit statistical sequence is C′[1]=2, so the prefix sum sequence is D′[1]=C′[0]+C′[1]=5; a 2nd element of the global digit statistical sequence is C′[2]=1, so the prefix sum sequence is D′[2]=C′[0]+C′[1]+C′[2]=6; a 3rd element of the global digit statistical sequence is C′[3]=1, so the prefix sum sequence is D′[3]=C′[0]+C′[1]+C′[2]+C′[3]=7. Following this computing method, the global prefix sum sequence shown in FIG. 15 may be obtained.

In another implementation, the global prefix sum sequence may be computed according to D′[i]=C′[i]+D′[i−1].

Therefore,

D′[0]=C′[0]=3;

D′[1]=C′[1]+D′[0]=2+3=5;

D′[2]=C′[2]+D′[1]=1+5=6;

D′[3]=C′[3]+D′[2]=1+6=7;

D′[4]=C′[4]+D′[3]=0+7=7;

D′[5]=C′[5]+D′[4]=0+7=7;

D′[6]=C′[6]+D′[5]=0+7=7;

D′[7]=C′[7]+D′[6]=1+7=8;

D′[8]=C′[8]+D′[7]=0+8=8;

D′[9]=C′[9]+D′[8]=0+8=8.

The global digit statistical sequence may reflect the amount of data in each logical digit. For example, if a corresponding value of a digit 0 in the global digit statistical sequence is 3, it is represented that there are three pieces of data that contain the digit 0. When these three pieces of data are written to a memory, conflicts among these pieces of data are required to be avoided. In another aspect, specific positions of corresponding data may be reflected according to the prefix sum obtained through the global digit statistical sequence and the corresponding global prefix sum sequence. Thus, the position of the data in the storage space may be determined according to the global prefix sum sequence to sort the data.

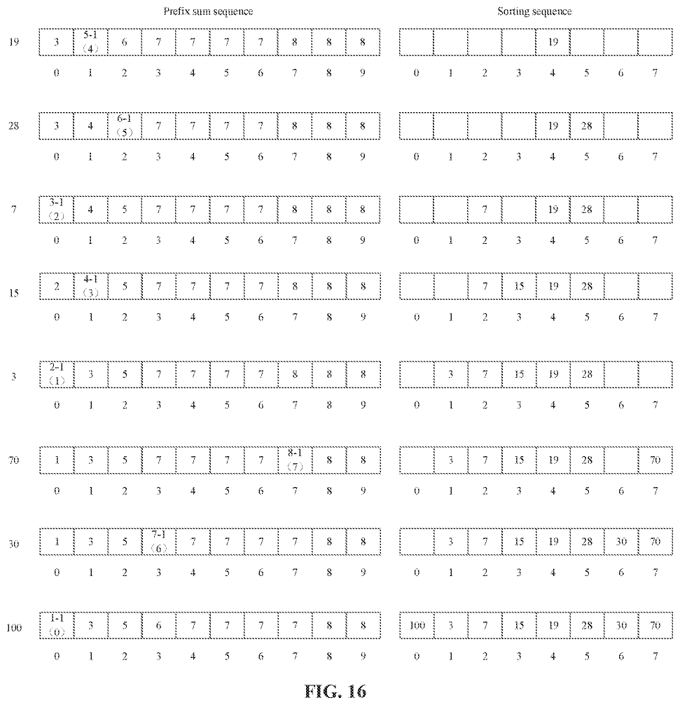

FIG. 16 shows a schematic diagram of determining a position of each piece of data according to a prefix sum sequence according to another implementation of the present disclosure.

Next, as shown in FIG. 16, forward traversal is performed from data 19 in the tail, and a prefix sum of a statistical count corresponding to a logical digit 1 in the prefix sum sequence is 5. A corresponding position of the data 19 should be 5−1=4. Therefore, the data 19 may be filled into a position corresponding to a position index 4. Additionally, the prefix sum corresponding to the logical digit 1 is subtracted by 1, so that the prefix sum becomes 4.

Next, the data 28 is traversed. At this time, a prefix sum of a statistical count corresponding to a logical digit 2 in the prefix sum sequence is 6. A corresponding position of the data 28 should be 5. Therefore, the data 28 may be filled into a position corresponding to a position index 5. Additionally, the prefix sum corresponding to the logical digit 2 is subtracted by 1, so that the prefix sum becomes 5.

Next, the data 7 is traversed, where a prefix sum of a statistical count corresponding to a logical digit 0 in the prefix sum sequence is 3. A corresponding position of the data 7 should be 3−1=2. Therefore, the data 7 may be filled into a position corresponding to a position index 2. Additionally, the prefix sum corresponding to the logical digit 0 is subtracted by 1, so that the prefix sum becomes 2.

Next, the data 15 is traversed, where a prefix sum of a statistical count corresponding to a logical digit 1 in the prefix sum sequence is 4. A corresponding position of the data 15 should be 4−1=3. Therefore, the data 15 may be filled into a position corresponding to a position index 3. Additionally, the prefix sum corresponding to the logical digit 1 is subtracted by 1, so that the prefix sum becomes 3.

Next, the data 3 is traversed, where a prefix sum of a statistical count corresponding to a logical digit 0 in the prefix sum sequence is 2. A corresponding position of the data 3 should be 1. Therefore, the data 3 may be filled into a position corresponding to a position index 1. Additionally, the prefix sum corresponding to the logical digit 0 is subtracted by 1, so that the prefix sum becomes 1.

Next, the data 70 is traversed, where a prefix sum of a statistical count corresponding to a logical digit 7 in the prefix sum sequence is 8. A corresponding position of the data 70 should be 8−1=7. Therefore, the data 70 may be filled into a position corresponding to a position index 7. Additionally, the prefix sum corresponding to the logical digit 7 is subtracted by 1, so that the prefix sum becomes 7.

Next, the data 30 is traversed, where a prefix sum of a statistical count corresponding to a logical digit 3 in the prefix sum sequence is 7. A corresponding position of the data 30 should be 7−1=6. Therefore, the data 30 may be filled into a position corresponding to a position index 6. Additionally, the prefix sum corresponding to the logical digit 3 is subtracted by 1, so that the prefix sum becomes 6.

Next, the data 100 is traversed, where a prefix sum of a statistical count corresponding to a logical digit 0 in the prefix sum sequence is 1. A corresponding position of the data 100 should be 1−1=0. Therefore, the data 100 may be filled into a position corresponding to a position index 0. Additionally, the prefix sum corresponding to the logical digit 0 is subtracted by 1, so that the prefix sum becomes 0.

Finally, the sorted data may be 100, 3, 7, 15, 19, 28, 30, and 70.

After the second round of sorting, other pieces of data have reached the desired sequence except the data 100. The data may be further sorted based on hundreds digits, thus obtaining the desired sequence 3, 7, 15, 19, 28, 30, 70, and 100. The sorting based on hundreds digits will not be repeated herein. The sorted data may be stored in the processing core for further use.

It is also required to be understood that FIG. 15 illustrates only an example of obtaining the sorting sequence according to the prefix sum sequence. According to another implementation of the present disclosure, it is possible to create only one sorting sequence and re-sort global data that has been sorted for the first time through one processing core; or according to another implementation of the present disclosure, it is possible to create the sorting sequence and re-sort the global data that has been sorted for the first time in parallel through a plurality of processing cores (as shown in FIG. 9); or according to another implementation of the present disclosure, it is possible to create a plurality of sorting sequences and re-sort the global data that has been sorted for the first time in parallel through the plurality of processing cores (as shown in FIG. 10). These solutions have been described in combination with FIG. 9 and FIG. 10 in the above, so these solutions will not be repeated herein.

The above has taken decimal data as an example for description. According to an implementation of the present disclosure, when the data is a floating point number, the floating point number is converted to a hexadecimal representation to sort the hexadecimal representation. By adopting the hexadecimal representation, better performance may be achieved.

For example, for a floating point number 3715.0, a corresponding hexadecimal representation is E83, so logical digits of the floating-point number may be E, 8, and 3.

Further, according to an implementation of the present disclosure, when the floating point number includes a negative number, all bits of a hexadecimal representation of the negative number are inverted; and when the floating point number further includes a positive number, a sign bit of a hexadecimal representation of the positive number is inverted. It is required to be understood that when the data is the decimal data and includes the negative number, it is possible to invert all bits of a binary of the negative decimal data and invert a sign bit of a binary representation of positive or non-negative decimal data in the decimal data. Then, the data may be sorted according to the above method.

Here takes the hexadecimal as an example for explanation. For example, there is a positive floating point number: b1=0011 0000 0000 0000 0000 0000 0000 1110, and then it is required to invert a sign bit of the positive number b1; in other words, the positive number b1 is converted to b1′=1011 0000 0000 0000 0000 0000 0000 1110, and the b1′ is expressed in hexadecimal format as 0XB000000E.

There is a negative floating point number: b2=1001 0101 0000 1001 0000 1001 0101 0000, and then it is required to invert all bits of the negative number b2; in other words, the negative number b2 is converted to b2′=0110 1010 1111 0110 1111 0110 1010 1111, and the b2′ is expressed in hexadecimal format as 0X6AF6F6AF.

For the hexadecimal, it is required to sort by the low-order digit first; in other words, it is required to sort based on E and F first and then further based on 0 and A, thus sorting these floating point numbers according to all bits of the hexadecimal.

The technical solution of the present disclosure provides a new full-vectorization sorting algorithm, which may be used for implementing fast sorting of data. This sorting algorithm is also suitable for sorting data in a processor that supports a vector operation, which helps to improve the performance and efficiency of the sorting.

The multi-core processor of the present disclosure may support the vector operation, which is conducive to improving the performance and efficiency of the sorting. The processor that supports the vector operation may implement vectorization through a vector instruction and perform operations on the data in parallel.

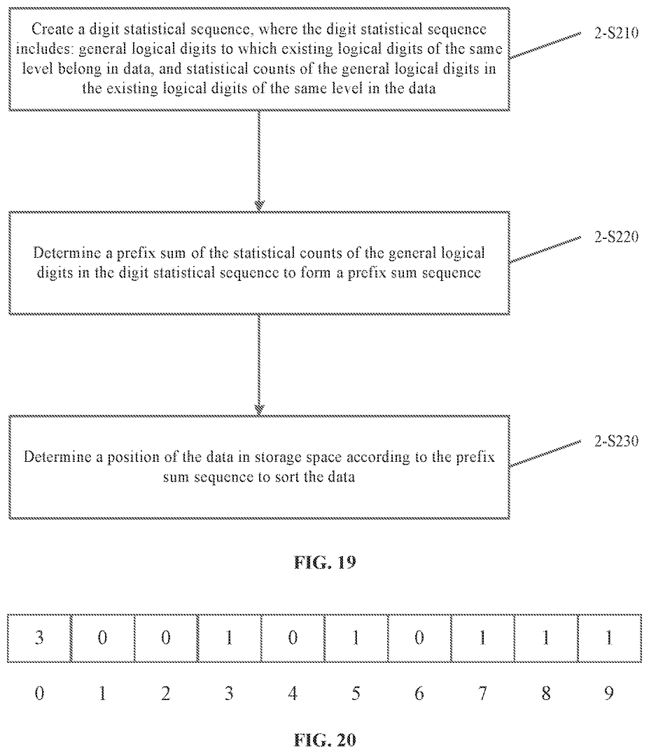

FIG. 19 shows a method for sorting data in a single-core processor according to an implementation of the present disclosure, and the method includes: in an operation 2-S210, creating a digit statistical sequence, where the digit statistical sequence includes: general logical digits to which existing logical digits of the same level belong in the data, and statistical counts of the general logical digits in the existing logical digits of the same level in the data; in an operation 2-S220, determining a prefix sum of the statistical counts of the general logical digits in the digit statistical sequence to form a prefix sum sequence; and in an operation 2-S230, determining a position of the data in storage space according to the prefix sum sequence to sort the data.

Firstly, concepts covered in FIG. 19 are explained.

The single-core processor described in the present disclosure refers to a processor with a processing core, or in a multi-core processor, when only one processing core is involved in the operation, the processor may also be called the single-core processor. The multi-core processor has been explained in combination with FIG. 1 in the above and will not be repeated herein.

The “data” mentioned above includes numbers and various other letters, symbols, strings, Chinese characters, and the like, that may be converted into numbers.

The “digits” mentioned above are “bits” of the data. For example, data 12 contains a digit 2 in the units place and a digit 1 in the tens place; data 108 contains a digit 8 in the units place, a digit 0 in the tens place, and a digit 1 in the hundreds place; and for example, data 5 contains a digit 5 in the units place, but may also be regarded as containing a digit 0 in the tens place, a digit 0 in the hundreds place, and so on.

The term “same level” mentioned above refers to digits in the same place in different data. For example, for data 18 and data 34, corresponding digits of the same level are 8 and 4 (units) and 1 and 3 (tens), respectively. For data 8 and data 34, corresponding digits of the same level are 8 and 4 (units) and 0 and 3 (tens), respectively.

A process of creating the digit statistical sequence is explained in combination with specific examples below. FIG. 20 shows a schematic diagram of an exemplary digit statistical sequence.

A logical digit refers to any form of representation of the digit of data. For decimal integers, digits are intuitive. For example, for an integer 123, the integer has three digits, including a hundreds digit 1, a tens digit 2, and a units digit 3, respectively. However, for floating-point numbers, digits are not intuitive. For example, for a floating-point number 3715.0, a corresponding hexadecimal representation is E83, so its logical digits may be E, 8, and 3.

Existing logical digits refers to digits actually contained in the data. For example, existing logical digits of the integer 123 are a hundreds digit 1, a tens digit 2, and a units digit 3, respectively; and existing logical digits of the floating-point number 3715.0 are E, 8, and 3. The existing logical digits belong to a large logical digit collection. For example, general logical digits to which the existing logical digits 1, 2, and 3 of the decimal belong are 0-9; and general logical digits to which the existing logical digits E, 8, and 3 of the hexadecimal belong are 0-F.

According to another implementation of the present disclosure, according to upper and lower limits of logical digits contained in the data participating in the sorting, the range of the general logical digits mentioned above may be the range limited by the upper and lower limits. For example, if the lower limit of the logical digits contained in the data participating in the sorting is 2, and the upper limit is 7, then the range of the general logical digits may be 2-7. Of course, it may be understood that this is just a special example, and in practice, the range corresponding to the base may be selected as the range of the general logical digits.

As shown in FIG. 20, eight pieces of data are stored in a certain processing core, such as 7, 15, 3, 100, 28, 19, 30, and 70. Moreover, these eight pieces of data 7, 15, 3, 100, 28, 19, 30, and 70 are required to be sorted based on units digits, and then, the number of each logical digit in the units place in these eight pieces of data may be counted. According to common cognition and “intuitive” judgment of human beings, if these pieces of data 7, 15, 3, 100, 28, 19, 30, and 70 are sorted from small to large based on units digits, the actual sequence of these pieces of data may be 100, 30, 70, 3, 15, 7, 28, and 19. It is required to be understood that if these pieces of data are sorted based on units digits, these three pieces of data 100, 30, and 70 may be sorted as 30, 70, and 100; these three pieces of data 100, 30, and 70 may be sorted as 70, 30, and 100; these three pieces of data 100, 30, and 70 may be sorted as 30, 100, and 70; or these three pieces of data 100, 30, and 70 may be sorted as 70, 100, and 30, and so on.

As shown in FIG. 20, in the digit statistical sequence, existing logical digits are 7, 5, 3, 0, 8, 9, 0, and 0, respectively; and general logical digits to which the existing logical digits belong are 0-9. Therefore, in the digit statistical sequence, a statistical count of a digit 0 is 3, a statistical count of a digit 1 is 0, a statistical count of a digit 2 is 0, a statistical count of a digit 3 is 1, a statistical count of a digit 4 is 0, a statistical count of a digit 5 is 1, a statistical count of a digit 6 is 0, a statistical count of a digit 7 is 1, a statistical count of a digit 8 is 1, and a statistical count of a digit 9 is 1.

Although the statistical counts shown in FIG. 20 are arranged in the ascending order of the general logical digits 0˜9, those skilled in the art may also arrange the statistical counts in the descending order of the general logical digits 9˜0. Different arrangements will result in different positions of each piece of data, which will be described later. It is required to be understood that there is no limit to how the general logical digits are arranged.

After the digit statistical sequence shown in FIG. 20 is obtained, a prefix sum of the digit statistical sequence may be computed. In other words, according to an implementation of the present disclosure, determining the prefix sum of the statistical counts of the general logical digits in the digit statistical sequence to form a prefix sum sequence includes: adding a statistical count of each logical digit in the digit statistical sequence to all preceding statistical counts to obtain a prefix sum; and storing the prefix sum in a corresponding position of each logical digit to form the prefix sum sequence.

The prefix sum is used to reflect a position of each element. The prefix sum may be expressed by a mathematical formula as C[i]=A[0]+A[1]+ . . . A[i], or the prefix sum may be expressed as C[i]=A[i]+C[i−1]. C represents a value of each element in the prefix sum sequence, A represents a value of each element in the digit statistical sequence, and i represents an index of an element in the prefix sum sequence or the digit statistical sequence.

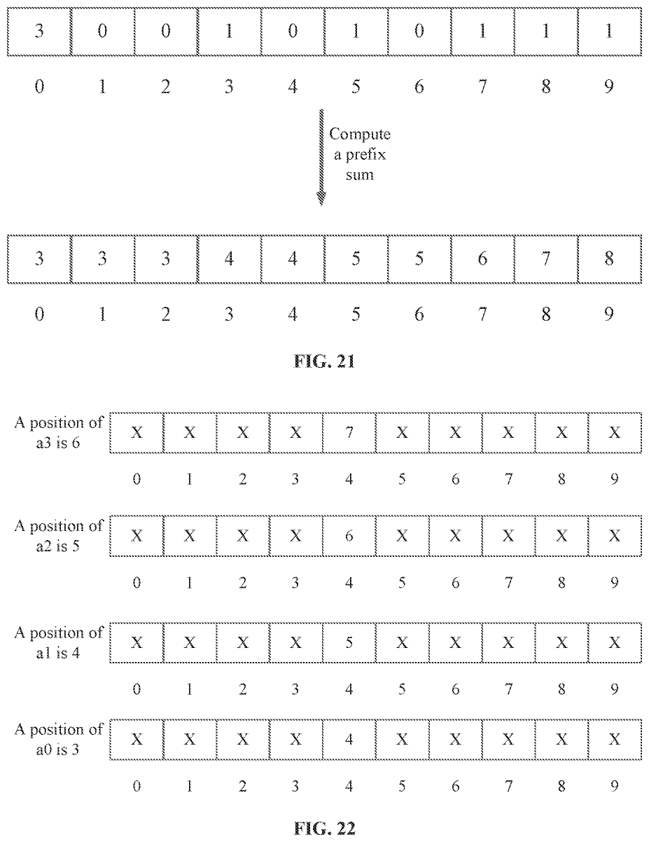

FIG. 21 describes a generation process of a prefix sum sequence using FIG. 20 as an example.

As shown in FIG. 21, a 0th element of the digit statistical sequence is A[0]=3, so the prefix sum sequence is C[0]=A[0]=3; a 1st element of the digit statistical sequence is A[1]=0, so the prefix sum sequence is C[1]=A[0]+A[1]=3; a 2nd element of the digit statistical sequence is A[2]=2, so the prefix sum sequence is C[2]=A[0]+A[1]+A[2]=3; a 3rd element of the digit statistical sequence is A[3]=1, so the prefix sum sequence is C[3]=A[0]+A[1]+A[2]+A[3]=4. Following this computing method, the prefix sum sequence shown in FIG. 21 may be obtained.

In another implementation, the prefix sum sequence may be computed according to C[i]=A[i]+C[i−1].

Therefore,

C[0]=A[0]=3;

C[1]=A[1]+C[0]=0+3=3;

C[2]=A[2]+C[1]=0+3=3;

C[3]=A[3]+C[2]=1+3=4;

C[4]=A[4]+C[3]=0+4=4;

C[5]=A[5]+C[4]=1+4=5;

C[6]=A[6]+C[5]=0+5=5;

C[7]=A[7]+C[6]=1+5=6;

C[8]=A[8]+C[7]=1+6=7;

C[9]=A[9]+C[8]=1+7=8.

The digit statistical sequence reflects the amount of data in each logical digit. For example, if a corresponding value of a digit 0 in the digit statistical sequence is 3, it is represented that there are three pieces of data that contain the digit 0. When these three pieces of data are written to a memory, conflicts among these pieces of data are required to be avoided. In another aspect, specific positions of corresponding data may be reflected according to the prefix sum obtained through the digit statistical sequence and the corresponding prefix sum sequence. Thus, the position of the data in the storage space may be determined according to the prefix sum sequence to sort the data.

FIG. 22 shows a logical relationship between a position of data and a prefix sum sequence of the data.

As shown in FIG. 22, assuming that four pieces of data a0, a1, a2, and a3 all contain a logical digit 4, and assuming that a prefix sum corresponding to the logical digit 4 is 7, a position of each piece of data that contains the logical digit may be determined based on the prefix sum 7. For clarity, a prefix sum of other logical digits is expressed as X, and a corresponding description is omitted. According to an implementation of the present disclosure, it is possible to traverse forward from the tail of data a0, a1, a2, and a3; in other words, a position of the data a3 is 7, a position of the data a2 is 7-1, a position of the data a1 is 7-2, and a position of the data a0 is 7-3. It is also possible to traverse backward from the header of the data a0, a1, a2, and a3; in other words, the position of the data a0 is 7, the position of the data a1 is 7-1, the position of the data a2 is 7-2, and the position of the data a3 is 7-3. It is also required to be understood that a first position is considered to be 1 in the above, and if the first position is considered to be 0, then when the data a0, a1, a2, and a3 are traversed forward from the tail, the position of the data a3 is 7-1, the position of the data a2 is 7-2, the position of the data a1 is 7-3, and the position of the data a0 is 7-4. When the data a0, a1, a2, and a3 are traversed backward from the header, the position of the data a0 is 7-1, the position of the data a1 is 7-2, the position of the data a2 is 7-3, and the position of the data a3 is 7-4. The above difference is only in the definition of the first position, which does not affect the overall description and understanding of the technology of the present disclosure.

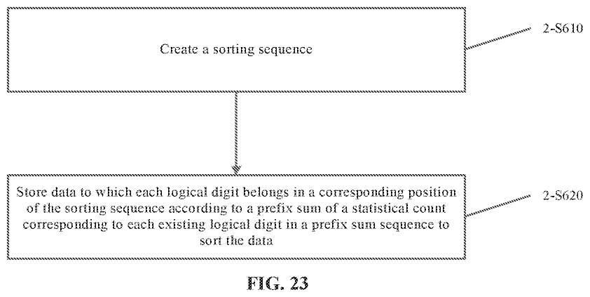

FIG. 23 shows a method flowchart of determining a position of data in storage space according to a prefix sum sequence according to an implementation of the present disclosure.

As shown in FIG. 23, operations shown in the flowchart include: in an operation 2-S610, creating a sorting sequence; and in an operation 2-S620, storing data to which each logical digit belongs in a corresponding position of the sorting sequence according to a prefix sum of a statistical count corresponding to each existing logical digit in the prefix sum sequence to sort the data.

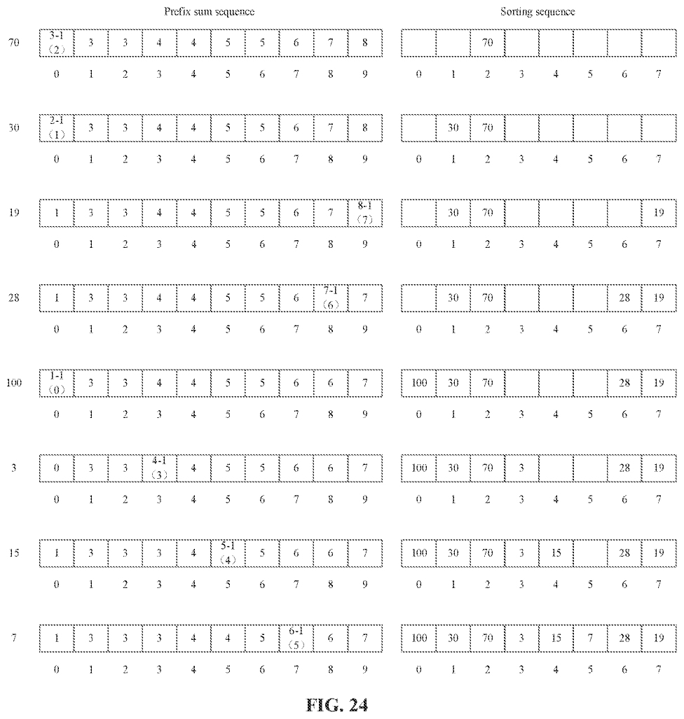

The method flowchart shown in FIG. 23 is first introduced in conjunction with FIG. 24.

As shown in FIG. 24, the sorting sequence is given, which gives position indexes 0-9 set from low to high order. A corresponding position above each position index is used to fill corresponding data, which represents the position of the data. It is required to be understood that as shown in the above, here, a first position is 0, so the prefix sum of the statistical count in the prefix sum sequence should be subtracted by 1 to indicate the position of the data.

The data 7, 15, 3, 100, 28, 19, 30, and 70 are still used as examples for explanation. This sorting is still based on units digits only and does not consider the effect of tens digits.

First, as shown in FIG. 24, forward traversal is performed from the tail data 70, a prefix sum of a statistical count corresponding to a logical digit 0 in the prefix sum sequence is 3. According to the explanation of FIG. 22, a corresponding position of the data 70 should be 3−1=2. Therefore, the data 70 may be filled into a position corresponding to a position index 2.

According to an implementation of the present disclosure, each time data to which each logical digit belongs is stored in a corresponding position of the sorting sequence, a prefix sum of a statistical count corresponding to the logical digit is subtracted by 1, thereby avoiding conflicts when a plurality of pieces of data corresponding to the same logical digit are written to memories or storage space.

According to this implementation, a prefix sum corresponding to a logical digit 0 is subtracted by 1, so that the prefix sum becomes 2.

Next, the data 30 is traversed. At this time, a corresponding position of the data 30 should be 2−1=1. Therefore, the data 30 may be filled into a position corresponding to a position index 1. Then, a prefix sum of a statistical count corresponding to the logical digit 0 in the prefix sum sequence may be subtracted by 1, thereby becoming 1.

Next, the data 19 is traversed, where a prefix sum of a statistical count corresponding to a logical digit 9 in the prefix sum sequence is 8. According to the explanation of FIG. 22, a corresponding position of the data 19 should be 8−1=7. Therefore, the data 19 may be filled into a position corresponding to a position index 7. Additionally, the prefix sum corresponding to the logical digit 9 is subtracted by 1, so that the prefix sum becomes 7.

Next, the data 28 is traversed, where a prefix sum of a statistical count corresponding to a logical digit 8 in the prefix sum sequence is 7. According to the explanation of FIG. 22, a corresponding position of the data 28 should be 7−1=6. Therefore, the data 28 may be filled into a position corresponding to a position index 6. Additionally, the prefix sum corresponding to the logical digit 8 is subtracted by 1, so that the prefix sum becomes 6.

Next, the data 100 is traversed, where a prefix sum of a statistical count corresponding to a logical digit 0 in the prefix sum sequence is 1. According to the explanation of FIG. 22, a corresponding position of the data 100 should be 1−1=0. Therefore, the data 100 may be filled into a position corresponding to a position index 0. Additionally, the prefix sum corresponding to the logical digit 0 is subtracted by 1, so that the prefix sum becomes 0.

Next, the data 3 is traversed, where a prefix sum of a statistical count corresponding to a logical digit 3 in the prefix sum sequence is 4. According to the explanation of FIG. 22, a corresponding position of the data 3 should be 4−1=3. Therefore, the data 3 may be filled into a position corresponding to a position index 3. Additionally, the prefix sum corresponding to the logical digit 3 is subtracted by 1, so that the prefix sum becomes 3.

Next, the data 15 is traversed, where a prefix sum of a statistical count corresponding to a logical digit 5 in the prefix sum sequence is 5. According to the explanation of FIG. 22, a corresponding position of the data 15 should be 5−1=4. Therefore, the data 15 may be filled into a position corresponding to a position index 4. Additionally, the prefix sum corresponding to the logical digit 5 is subtracted by 1, so that the prefix sum becomes 4.

Next, the data 7 is traversed, where a prefix sum of a statistical count corresponding to a logical digit 7 in the prefix sum sequence is 6. According to the explanation of FIG. 22, a corresponding position of the data 7 should be 6−1=5. Therefore, the data 7 may be filled into a position corresponding to a position index 5. Additionally, the prefix sum corresponding to the logical digit 7 is subtracted by 1, so that the prefix sum becomes 5.

Finally, the sorted data may be 100, 30, 70, 3, 15, 7, 28, and 19.

The sorting based on a certain level of logical digit (such as units) has been described in the above, while in another implementation, the overall data may be further sorted. For the above sequence, the expected sequence from small to large is 3, 7, 15, 19, 28, 30, 70, and 100. Thus, the data may be further sorted based on the sequence above.

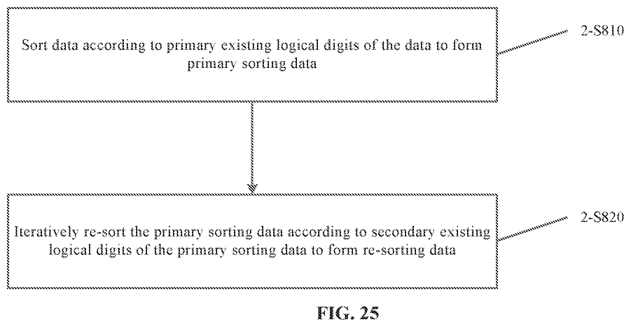

FIG. 25 shows a method for sorting data in a single-core processor according to another implementation of the present disclosure, including: in an operation 2-S810, sorting data according to primary existing logical digits of the data to form primary sorting data; and in an operation 2-S820, iteratively re-sorting the primary sorting data according to secondary existing logical digits of the primary sorting data to form re-sorting data.

At present, no data sorting solution based on multilevel digits has been found. The technical solution of the present disclosure adopts multilevel sorting to adjust the position of the data step by step, so as to finally realize data sorting.

For the operation 2-S810, sorting the data according to the primary existing logical digits of the data to form the primary sorting data may include: creating a primary digit statistical sequence, where the primary digit statistical sequence includes: primary general logical digits to which primary existing logical digits belong in the data, and primary statistical counts of the primary general logical digits in the primary existing logical digits of the data; determining a prefix sum of the primary general logical digits in the primary digit statistical sequence to form a primary prefix sum sequence; and determining a primary position of the data in storage space according to the primary prefix sum sequence to sort the data, thereby forming the primary sorting data.

The above has explained the operation by taking the data 7, 15, 3, 100, 28, 19, 30, and 70 as examples, and the obtained primary sorting global data may be 100, 30, 70, 3, 15, 7, 28, and 19. The primary sorting data is sorted based on units digits, which will not be repeated herein.

Similarly, the primary statistical counts are sorted in the ascending or descending order of the primary general logical digits.

According to an implementation of the present disclosure, determining the prefix sum of the primary statistical counts of the primary general logical digits in the primary digit statistical sequence to form the primary prefix sum sequence may include: adding a primary statistical count of each primary digit in the primary digit statistical sequence to all preceding primary statistical counts to obtain the prefix sum; and storing the prefix sum in a corresponding primary position of each primary digit to form the primary prefix sum sequence.

The computing processing of the prefix sum has been explained in combination with FIG. 21 in the above and will not be repeated herein.

According to an implementation of the present disclosure, determining the primary position of the data in the storage space according to the primary prefix sum sequence to sort the data to form the primary sorting data may include: creating a primary sorting sequence; and storing data to which each primary digit belongs in a corresponding position of the primary sorting sequence according to a prefix sum of a primary statistical count corresponding to each primary existing logical digit in the primary prefix sum sequence to sort the data to form the primary sorting data. In some embodiments, each time data to which each primary digit belongs is stored in a corresponding position of the primary sorting sequence, a prefix sum of the primary statistical count is subtracted by 1.

Determining the primary position of the data in the storage space according to the primary prefix sum sequence has been explained in combination with FIG. 24 in the above and will not be repeated herein.

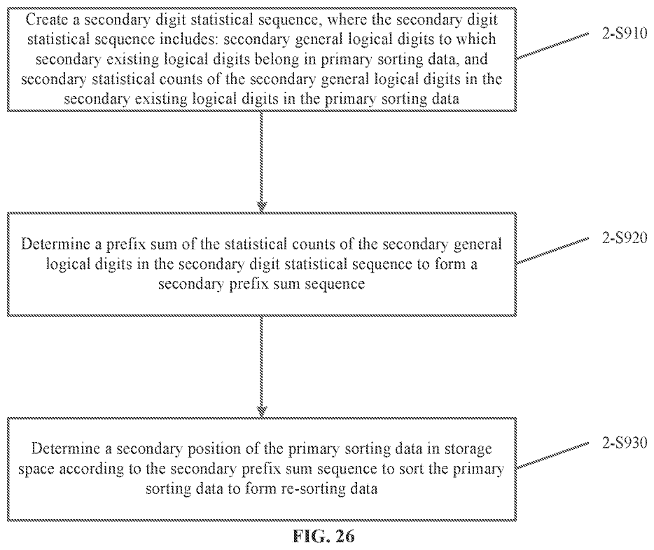

FIG. 26 shows a flow diagram of iteratively re-sorting primary sorting data according to secondary existing logical digits of the primary sorting data to form re-sorting data according to an implementation of the present disclosure.

As shown in FIG. 26, iteratively re-sorting the primary sorting data according to the secondary existing logical digits of the primary sorting data to form the re-sorting data may include: in an operation 2-S910, creating a secondary digit statistical sequence, where the secondary digit statistical sequence includes: secondary general logical digits to which secondary existing logical digits belong in the primary sorting data, and secondary statistical counts of the secondary general logical digits in the secondary existing logical digits of the primary sorting data; in an operation 2-S920, determining a prefix sum of statistical counts of the secondary general logical digits in the secondary digit statistical sequence to form a secondary prefix sum sequence; and in an operation 2-S930, determining a secondary position of the primary sorting data in storage space according to the secondary prefix sum sequence to re-sort the primary sorting data to form the re-sorting data.

The data may be further sorted based on the tens digits of the data above. After the data is further sorted based on the tens digits of the data, the data may be sorted based on the hundreds digits of the data.

It may be understood that for the primary sorting data 100, 30, 70, 3, 15, 7, 28, and 19, the prefix sum sequence may be created based on the tens digits of these pieces of data.

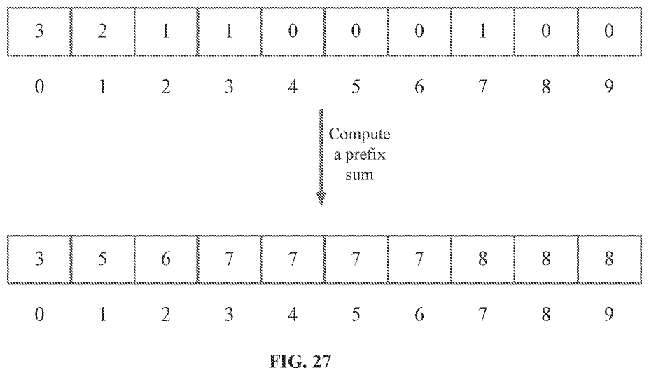

FIG. 27 shows a process of creating a prefix sum sequence based on secondary existing logical digits of data.

As shown in FIG. 27, in the digit statistical sequence based on secondary digits (tens digits), existing logical digits are 0, 3, 7, 0, 1, 0, 2, and 1, respectively, and general logical digits to which the existing logical digits belong are 0-9. Therefore, in the digit statistical sequence, a statistical count of a digit 0 is 3, a statistical count of a digit 1 is 2, a statistical count of a digit 2 is 1, a statistical count of a digit 3 is 1, a statistical count of a digit 4 is 0, a statistical count of a digit 5 is 0, a statistical count of a digit 6 is 0, a statistical count of a digit 7 is 1, a statistical count of a digit 8 is 0, and a statistical count of a digit 9 is 0.

Further, according to the method for computing the prefix sum shown in FIG. 21, the prefix sum sequence obtained based on tens digits includes:

C[0]=A[0]=3;

C[1]=A[1]+C[0]=2+3=5;

C[2]=A[2]+C[1]=1+5=6;

C[3]=A[3]+C[2]=1+6=7;

C[4]=A[4]+C[3]=0+7=7;

C[5]=A[5]+C[4]=0+7=7;

C[6]=A[6]+C[5]=0+7=7;

C[7]=A[7]+C[6]=1+7=8;

C[8]=A[8]+C[7]=0+8=8;

C[9]=A[9]+C[8]=0+8=8.

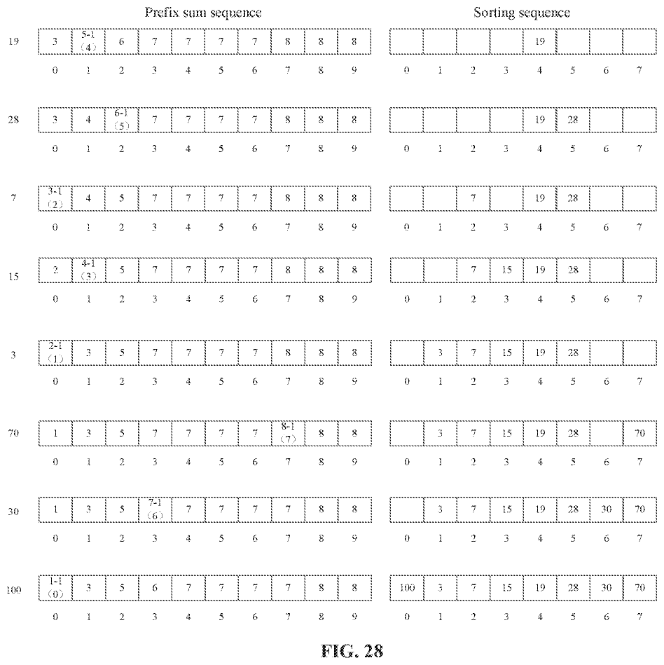

FIG. 28 shows a schematic diagram of determining a position of each piece of data according to a prefix sum sequence according to another implementation of the present disclosure.

Next, as shown in FIG. 28, forward traversal is performed from the tail data 19, a prefix sum of a statistical count corresponding to a logical digit 1 in the prefix sum sequence is 5. A corresponding position of the data 19 should be 5−1=4. Therefore, the data 19 may be filled into a position corresponding to a position index 4. Additionally, the prefix sum corresponding to the logical digit 1 is subtracted by 1, so that the prefix sum becomes 4. Next, the data 28 is traversed. At this time, a prefix sum of a statistical count corresponding to a logical digit 2 in the prefix sum sequence is 6. A corresponding position of the data 28 should be 5. Therefore, the data 28 may be filled into a position corresponding to a position index 5. Additionally, the prefix sum corresponding to the logical digit 2 is subtracted by 1, so that the prefix sum becomes 5.

Next, the data 7 is traversed, where a prefix sum of a statistical count corresponding to a logical digit 0 in the prefix sum sequence is 3. A corresponding position of the data 7 should be 3−1=2. Therefore, the data 7 may be filled into a position corresponding to a position index 2. Additionally, the prefix sum corresponding to the logical digit 0 is subtracted by 1, so that the prefix sum becomes 2.

Next, the data 15 is traversed, where a prefix sum of a statistical count corresponding to a logical digit 1 in the prefix sum sequence is 4. A corresponding position of the data 15 should be 4−1=3. Therefore, the data 15 may be filled into a position corresponding to a position index 3. Additionally, the prefix sum corresponding to the logical digit 1 is subtracted by 1, so that the prefix sum becomes 3.

Next, the data 3 is traversed, where a prefix sum of a statistical count corresponding to a logical digit 0 in the prefix sum sequence is 2. A corresponding position of the data 3 should be 1. Therefore, the data 3 may be filled into a position corresponding to a position index 1. Additionally, the prefix sum corresponding to the logical digit 0 is subtracted by 1, so that the prefix sum becomes 1.

Next, the data 70 is traversed, where a prefix sum of a statistical count corresponding to a logical digit 7 in the prefix sum sequence is 8. A corresponding position of the data 70 should be 8−1=7. Therefore, the data 70 may be filled into a position corresponding to a position index 7. Additionally, the prefix sum corresponding to the logical digit 7 is subtracted by 1, so that the prefix sum becomes 7.

Next, the data 30 is traversed, where a prefix sum of a statistical count corresponding to a logical digit 3 in the prefix sum sequence is 7. A corresponding position of the data 30 should be 7−1=6. Therefore, the data 30 may be filled into a position corresponding to a position index 6. Additionally, the prefix sum corresponding to the logical digit 3 is subtracted by 1, so that the prefix sum becomes 6.

Next, the data 100 is traversed, where a prefix sum of a statistical count corresponding to a logical digit 0 in the prefix sum sequence is 1. A corresponding position of the data 100 should be 1−1=0. Therefore, the data 100 may be filled into a position corresponding to a position index 0. Additionally, the prefix sum corresponding to the logical digit 0 is subtracted by 1, so that the prefix sum becomes 0.

Finally, the sorted data may be 100, 3, 7, 15, 19, 28, 30, and 70.

After the second round of sorting, other pieces of data have reached the desired sequence except the data 100. The data may be further sorted based on hundreds digits, thus obtaining the desired sequence 3, 7, 15, 19, 28, 30, 70, and 100. The sorting based on hundreds digits will not be repeated herein. The sorted data may be stored in the processing core for further use.

The above has taken decimal data as an example for description. According to an implementation of the present disclosure, when the data is a floating point number, the floating point number is converted to a hexadecimal representation to sort the hexadecimal representation. By adopting the hexadecimal representation, better performance may be achieved.

For example, for a floating point number 3715.0, a corresponding hexadecimal representation is E83, so its logical digits should be E, 8, and 3.

Further, according to an implementation of the present disclosure, when the floating point number includes a negative number, all bits of a hexadecimal representation of the negative number are inverted; and when the floating point number further includes a positive number, a sign bit of a hexadecimal representation of the positive number is inverted. It is required to be understood that when the data is the decimal data and includes the negative number, it is possible to invert all bits of a binary of the negative decimal data and invert a sign bit of a binary representation of positive or non-negative decimal data in the decimal data. Then, the data may be sorted according to the above method.

Here takes the hexadecimal as an example for explanation. For example, there is a positive floating point number: b1=0011 0000 0000 0000 0000 0000 0000 1110, and then it is required to invert a sign bit of the positive number b1; in other words, the positive number b1 is converted to b1′=1011 0000 0000 0000 0000 0000 0000 1110, and the b1′ is expressed in hexadecimal format as 0XB000000E.

There is a negative floating point number: b2=1001 0101 0000 1001 0000 1001 0101 0000, and then it is required to invert all bits of the negative number b2; in other words, the negative number b2 is converted to b2′=0110 1010 1111 0110 1111 0110 1010 1111, and the b2′ is expressed in hexadecimal format as 0X6AF6F6AF.

For the hexadecimal, it is required to sort by the low-order digit first; in other words, it is required to sort based on E and F first and then further based on 0 and A, thus sorting these floating point numbers according to all bits of the hexadecimal.

The technical solution of the present disclosure provides a new sorting algorithm based on full vectorization, which may be used for implementing fast sorting of data. This sorting algorithm is also suitable for sorting data in a processor that supports a vector operation, which helps to improve the performance and efficiency of the sorting.

The single-core processor of the present disclosure may support the vector operation, which is conducive to improving the performance and efficiency of the sorting. The processor that supports the vector operation may implement vectorization through a vector instruction and perform operations on the data in parallel.

The present disclosure also provides an electronic device. The electronic device includes: one or a plurality of processors; and a memory, on which a computer-executable instruction is stored, where when the computer-executable instruction is run by the one or the plurality of processors, the electronic device performs the method described above.

The present disclosure also provides a computer-readable storage medium, including a computer-executable instruction, where when the computer-executable instruction is run by one or a plurality of processors, the method described above is performed.

The technical solution of the present disclosure may be applied to the field of artificial intelligence and may be implemented as or may be implemented in an artificial intelligence chip. Moreover, this sorting algorithm is suitable for sorting data in an AI chip/processor, improving the efficiency of data sorting in the AI chip/processor. The chip may stand alone or may be included in a computing apparatus.

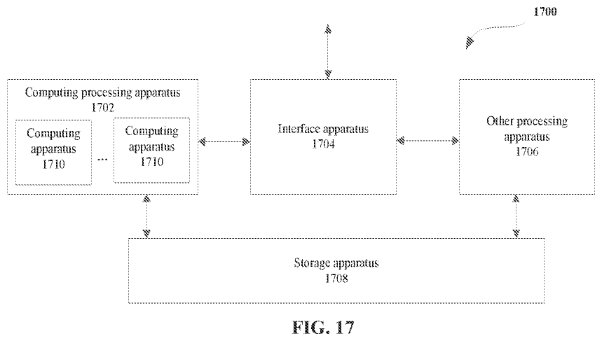

FIG. 17 shows a combined processing apparatus 1700, including the aforementioned computing apparatus 1702, a general interconnection interface 1704, and other processing apparatus 1706. The computing apparatus of the present disclosure interacts with other processing apparatus to jointly complete an operation specified by a user. FIG. 17 is a schematic diagram of the combined processing apparatus.

Other processing apparatus includes one or more types of general/dedicated processors, such as a central processing unit (CPU), a graphics processing unit (GPU), and a neural network processor. The present disclosure does not restrict a count of processors included in other processing apparatus. Other processing apparatus serves as an interface between a machine learning operation apparatus and external data and controls, including data moving, and completes basic controls such as starting and stopping the machine learning operation apparatus. Additionally, other processing apparatus may also cooperate with the machine learning operation apparatus to complete an operation task.

The general interconnection interface is used to transfer data and control instructions between the computing apparatus (including, for example, the machine learning operation apparatus) and other processing apparatus. The computing apparatus acquires required input data from other processing apparatus and writes the data in an on-chip storage apparatus of the computing apparatus. The computing apparatus may also acquire control instructions from other processing apparatus and write the control instructions in an on-chip control cache of the computing apparatus. Additionally, the computing apparatus may further read data stored in the storage unit of the computing apparatus and transfer the data to other processing apparatus.

Optionally, this structure may further include a storage apparatus 1708. The storage apparatus is connected to the computing apparatus and other processing apparatus, respectively. The storage apparatus is used to save data of the computing apparatus and other processing apparatus. The storage apparatus is especially suitable for saving data that may not be completely stored in the internal storage of the computing apparatus or other processing apparatus of the present disclosure.

The combined processing apparatus may be used as a system on chip (SOC) of a device including a mobile phone, a robot, a drone, a video surveillance device, and the like. As such, a core area of a control part may be decreased effectively, processing speed may be improved, and overall power consumption may be reduced. In this case, the general interconnection interface of the combined processing apparatus is connected to some components of the device. The components include, for example, a webcam, a monitor, a mouse, a keyboard, a network card, and a WIFI interface.

In some embodiments, the present disclosure also provides a chip package structure, including the above-mentioned chip.

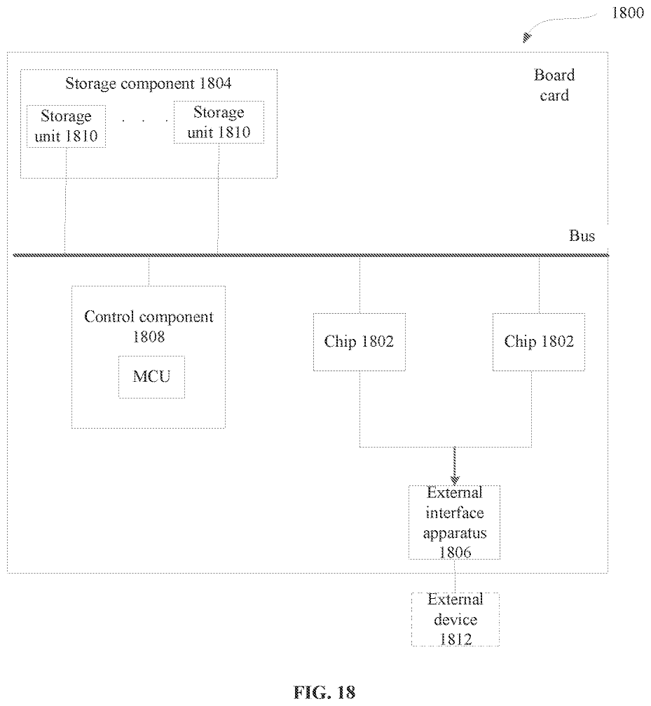

In some embodiments, the present disclosure provides a board card, including the chip package structure above. Referring to FIG. 18, an exemplary board card is provided.

The board card, in addition to the aforementioned chip 1802, may further include other supporting components. The supporting components include, but are not limited to, a storage component 1804, an interface apparatus 1806, and a control component 1808.

The storage component is connected to the chip in the chip package structure through a bus and is used to store data. The storage component may include a plurality of groups of storage units 1810. Each group of storage units is connected to the chip through the bus. It may be understood that each group of storage units may be a double data rate (DDR) synchronous dynamic random access memory (SDRAM).

The DDR doubles the speed of the SDRAM without increasing clock frequency. The DDR allows data to be read on rising and falling edges of a clock pulse. The speed of the DDR is twice of a standard SDRAM. In an embodiment, the storage component may include four groups of storage units. Each group of storage units may include a plurality of DDR4 particles (chips). In an embodiment, four 72-bit DDR4 controllers may be arranged inside the chip, where 64 bits of the 72-bit DDR4 controller described above are used for data transfer, and 8 bits are used for error checking and correcting (ECC) parity.

In an embodiment, each group of storage units includes a plurality of DDR SDRAMs arranged in parallel. The DDR may transfer data twice per clock cycle. A controller for controlling the DDR may be arranged in the chip, and the controller is used to control data transfer and data storage of each storage unit.

The interface apparatus is electrically connected to the chip in the chip package structure. The interface apparatus is used to implement data transfer between the chip and an external device 1812 (such as a server or a computer). For example, in an embodiment, the interface apparatus may be a standard peripheral component interconnect express (PCIe) interface. For instance, to-be-processed data is transferred by the server through the standard PCIe interface to the chip, so as to implement data transfer. In another embodiment, the interface apparatus may also be other interfaces. The present disclosure does not limit specific forms of other interfaces mentioned above, as long as an interface unit may realize a switching function. Additionally, a computing result of the chip is still sent back to the external device (such as the server) through the interface apparatus.

The control component is electrically connected to the chip. The control component is used to monitor a state of the chip. Specifically, the chip and the control component may be electrically connected through a serial peripheral interface (SPI). The control component may include a micro controller unit (MCU). If the chip may include a plurality of processing chips, a plurality of processing cores, or a plurality of processing circuits, the chip may be capable of driving a plurality of loads. Therefore, the chip may be in different working states, such as a multi-load state and a light-load state. Through the control component, regulation and controls of working states of the plurality of processing chips, the plurality of processing cores, and/or the plurality of processing circuits in the chip may be implemented.

In some embodiments, the present disclosure further discloses an electronic device or apparatus, including the above-mentioned board card.

The electronic device or apparatus may include a data processing apparatus, a robot, a computer, a printer, a scanner, a tablet, a smart terminal, a mobile phone, a traffic recorder, a navigator, a sensor, a webcam, a server, a cloud server, a camera, a video camera, a projector, a watch, a headphone, a mobile storage, a wearable device, a vehicle, a household appliance, and/or a medical device.

The vehicle may include an airplane, a ship, and/or a car. The household appliance may include a television, an air conditioner, a microwave oven, a refrigerator, an electric rice cooker, a humidifier, a washing machine, an electric lamp, a gas cooker, and a range hood. The medical device may include a nuclear magnetic resonance spectrometer, a B-ultrasonic scanner, and/or an electrocardiograph.

It is required to be explained that for the sake of conciseness, the foregoing method embodiments are all described as a series of combinations of actions, but those skilled in the art should know that the present disclosure is not limited by the described order of action since some steps may be performed in a different order or simultaneously according to the present disclosure. Moreover, those skilled in the art should also understand that embodiments described in the specification are all optional, and actions and units involved are not necessarily required for the present disclosure.

In the examples above, the description of each embodiment has its own emphasis. For a part that is not described in detail in one embodiment, reference may be made to related descriptions in other embodiments.

In several embodiments provided in the present disclosure, it should be understood that the apparatus disclosed may be implemented in other ways. For instance, the apparatus embodiments above are merely illustrative. For instance, a division of units is only a logical function division. In an actual implementation, there may be other division methods. For instance, a plurality of units or components may be combined or may be integrated in another system, or some features may be ignored or may not be performed. In addition, the displayed or discussed mutual coupling or direct coupling or communication connection may be implemented through indirect coupling or communication connection of some interfaces, apparatuses, or units, and may be in electrical, optical, acoustic, magnetic, or other forms.

Units described as separate components may or may not be physically separated. Components shown as units may or may not be physical units. In other words, the components may be located in one place or distributed to a plurality of network units. According to actual requirements, some or all of the units may be selected for achieving purposes of the embodiments of the present disclosure.

Additionally, each functional unit in each embodiment of the present disclosure may be integrated in one processing unit, or each unit may exist separately and physically, or two or more units may be integrated in one unit. The integrated unit described above may be implemented either in the form of hardware or in the form of a software program unit.

If the integrated unit is implemented in the form of the software program unit and sold or used as an independent product, the integrated unit may be stored in a computer-readable memory. Based on such understanding, when the technical solution of the present disclosure is embodied in the form of a software product, the software product may be stored in a memory. The software product includes several instructions used to enable a computer device (which may be a personal computer, a server, or a network device, and the like) to perform all or part of steps of the method of the embodiments of the present disclosure. The memory includes: a USB flash drive, a read-only memory (ROM), a random access memory (RAM), a mobile hard disk, a magnetic disk, or an optical disc, and other media that may store a program code.

The embodiments of the present disclosure have been described in detail above. The present disclosure explains principles and implementations of the present disclosure with specific examples. Descriptions of the embodiments above are only used to facilitate understanding of the method and core ideas of the present disclosure. Simultaneously, those skilled in the art may change the specific implementations and application scope of the present disclosure based on the ideas of the present disclosure. In summary, the content of this specification should not be construed as a limitation on the present disclosure.

Through following articles, the technical solution of the present disclosure may be better understood.

Article A1. A method for sorting global data in a multi-core processor, where the multi-core processor includes a plurality of processing cores, at least two of the processing cores store local data used as part of the global data, and the method includes:
creating a local digit statistical sequence, where the local digit statistical sequence includes: local general logical digits to which local existing logical digits of the same level belong in the local data, and local statistical counts of the local general logical digits in the local existing logical digits of the same level in the local data;
forming a global digit statistical sequence according to the local digit statistical sequence, where the global digit statistical sequence includes: global general logical digits to which global existing logical digits of the same level belong in the global data, and global statistical counts of the global general logical digits in the global existing logical digits of the same level in the global data;
determining a prefix sum of the global statistical counts of the global general logical digits in the global digit statistical sequence to form a global prefix sum sequence; and determining a position of the global data in storage space according to the global prefix sum sequence to sort the global data.

Article A2. The method of article A1, where the local statistical counts are sorted in an ascending or descending order of the local general logical digits.

Article A3. The method of article A1 or A2, where forming the global digit statistical sequence according to the local digit statistical sequence includes: adding a plurality of local digit statistical sequences accordingly to form the global digit statistical sequence.

Article A4. The method of any one of articles A1-A3, where the plurality of processing cores are connected to shared memories and communicate through the shared memories, thereby forming the global digit statistical sequence according to the local digit statistical sequence.

Article A5. The method of any one of articles A1-A4, where the plurality of processing cores are divided into a plurality of processing core groups, in each processing core group, processing cores of the same group are connected to a shared memory, and the plurality of processing core groups communicate through respective shared memories, thereby forming the global digit statistical sequence according to the local digit statistical sequence.

Article A6. The method of article A5, where the multi-core processor includes a global memory, and the plurality of processing cores are directly connected to the global memory, or the plurality of processing cores are indirectly connected to the global memory through the shared memories, thereby forming the global digit statistical sequence according to the local digit statistical sequence.

Article A7. The method of any one of articles A1-A6, where determining the prefix sum of the global statistical counts of the general logical digits in the global digit statistical sequence to form the global prefix sum sequence includes:
adding the global statistical counts of the global general logical digits in the global digit statistical sequence to all preceding global statistical counts to obtain a global prefix sum; and
storing the global prefix sum in a corresponding position of each digit in the general logical digits to form the global prefix sum sequence.

Article A8. The method of any one of articles A1-A7, where determining the position of the global data in the storage space according to the global prefix sum sequence to sort the global data includes:
creating a sorting sequence; and
storing global data to which each global existing logical digit belongs in a corresponding position of the sorting sequence according to a prefix sum of a global statistical count corresponding to each global existing logical digit in the global prefix sum sequence to sort the global data.

Article A9. The method of article A8, where
the sorting sequence is a global sorting sequence, where the global sorting sequence includes positions of global existing logical digits; and
through a processing core, storing the global data to which each global existing logical digit belongs in the corresponding position of the sorting sequence according to the prefix sum of the global statistical count corresponding to each global existing logical digit in the global prefix sum sequence to sort the global data.

Article A10. The method of article A8, where
the sorting sequence is a global sorting sequence, where the global sorting sequence includes positions of global existing logical digits;
dividing the global prefix sum sequence into a plurality of local prefix sum sequences, where the local prefix sum sequences include local prefix sums of local existing logical digits of the same level; and
through a plurality of processing cores, storing local data to which each local existing logical digit belongs in a corresponding position of the global sorting sequence in parallel according to a local prefix sum of each local existing logical digit of the same level in the local prefix sum sequence to sort the global data.

Article A11. The method of article A8, where
the sorting sequence includes a plurality of local sorting sequences, where the local sorting sequences include positions of local existing logical digits;
dividing the global prefix sum sequence into a plurality of local prefix sum sequences, where the local prefix sum sequences include local prefix sums of local existing logical digits of the same level; and
through a plurality of processing cores, storing local data to which each local existing logical digit belongs in corresponding positions of the local sorting sequences respectively in parallel according to a local prefix sum of each local existing logical digit of the same level in the local prefix sum sequences to sort the global data.

Article A12. The method of any one of articles A8-A11, further including:
each time the global data to which each global existing logical digit belongs or local data to which each local existing logical digit belongs is stored in the corresponding position of the sorting sequence, subtracting one from the prefix sum of the global statistical count or the local prefix sum.

Article A13. The method of any one of articles A8-A12, further including:
dividing sorted global data into a plurality of groups of sorted local data; and
storing the plurality of groups of sorted local data in the plurality of processing cores respectively.

Article A14. The method of any one of articles A1-A13, where the global data is decimal data; in some embodiments, when the decimal data includes a negative number, all bits of a binary representation of the negative decimal data are inverted; and when the decimal data further includes a positive number, a sign bit of a binary representation of the positive decimal data is inverted.

Article A15. The method of any one of articles A1-A13, where, when the global data is a floating point number, the floating point number is converted to a hexadecimal representation to sort the hexadecimal representation.

Article A16. The method of article A15, where, when the floating point number includes a negative number, all bits of a hexadecimal representation of the negative number are inverted; and when the floating point number further includes a positive number, a sign bit of a hexadecimal representation of the positive number is inverted.

Article A17. A method for sorting global data in a multi-core processor, where the multi-core processor includes a plurality of processing cores, at least two of the processing cores store local data used as part of the global data, and the method includes:
sorting the global data according to primary existing global logical digits of the global data to form primary sorting global data; and iteratively re-sorting the primary sorting global data according to secondary existing global logical digits of the primary sorting global data to form re-sorting global data.

Article A18. The method of article A17, where sorting the global data according to the primary existing global logical digits of the global data to form the primary sorting global data includes:
creating a primary local digit statistical sequence, where the primary local digit statistical sequence includes: primary local general logical digits to which primary local existing logical digits belong in the local data, and primary local statistical counts of the primary general logical digits in the primary local existing logical digits;
forming a primary global digit statistical sequence according to the primary local digit statistical sequence, where the primary global digit statistical sequence includes: global general logical digits to which primary global existing logical digits belong in the global data, and primary global statistical counts of the global general logical digits in the primary global existing logical digits;
determining a prefix sum of the primary global statistical counts of the global general logical digits in the primary global digit statistical sequence to form a primary global prefix sum sequence; and
determining a primary position of the global data in storage space according to the primary global prefix sum sequence to sort the global data.

Article A19. The method of article A17 or article A18, further including:
dividing the primary sorting global data into a plurality of groups of primary local sorting data; and
storing the plurality of groups of primary local sorting data in the plurality of processing cores respectively.

Article A20. The method of article A18, where the primary local statistical counts are sorted in an ascending or descending order of the primary general logical digits.

Article A21. The method of any one of articles A18-A20, where forming the primary global digit statistical sequence according to the primary local digit statistical sequence includes:
adding a plurality of primary local digit statistical sequences accordingly to form the primary global digit statistical sequence.

Article A22. The method of any one of articles A18-A21, where the plurality of processing cores are connected to shared memories and communicate through the shared memories, thereby forming the primary global digit statistical sequence according to the primary local digit statistical sequence.

Article A23. The method of any one of articles A18-A22, where the plurality of processing cores are divided into a plurality of processing core groups, in each processing core group, processing cores of the same group are connected to a shared memory, and the plurality of processing core groups communicate through respective shared memories, thereby forming the primary global digit statistical sequence according to the primary local digit statistical sequences.

Article A24. The method of article 23, where the multi-core processor includes a global memory, and the plurality of processing cores are directly connected to the global memory, or the plurality of processing cores are indirectly connected to the global memory through the shared memories, thereby forming the primary global digit statistical sequence according to the primary local digit statistical sequences.

Article A25. The method of any one of articles A18-A24, where determining the prefix sum of the primary global statistical counts of the global general logical digits in the primary global digit statistical sequence to form the primary global prefix sum sequence includes:
adding the primary global statistical counts of the global general logical digits in the primary global digit statistical sequence to all preceding primary global statistical counts to obtain a primary global prefix sum; and
storing the primary global prefix sum in a corresponding position of each digit in the general logical digits to form the primary global prefix sum sequence.

Article A26. The method of any one of articles A18-A25, where determining the primary position of the global data in the storage space according to the primary global prefix sum sequence to sort the global data includes:
creating a sorting sequence; and
storing global data to which each primary global existing logical digit belongs in a corresponding position of the sorting sequence according to a prefix sum of a primary global statistical count corresponding to each primary global existing logical digit in the primary global prefix sum sequence to sort the global data.

Article A27. The method of article A26, where
the sorting sequence is a primary global sorting sequence, where the primary global sorting sequence includes positions of primary global existing logical digits; and
through a processing core, storing the global data to which each primary global existing logical digit belongs in the corresponding position of the sorting sequence according to the prefix sum of the primary global statistical count corresponding to each primary global existing logical digit in the primary global prefix sum sequence to sort the global data.

Article A28. The method of article A26, where
the sorting sequence is a primary global sorting sequence, where the primary global sorting sequence includes positions of primary global existing logical digits;
dividing the primary global prefix sum sequence into a plurality of primary local prefix sum sequences, where the primary local prefix sum sequences include local prefix sums of primary local existing logical digits; and
through a plurality of processing cores, storing local data to which each primary local existing logical digit belongs in a corresponding position of the primary global sorting sequence in parallel according to a local prefix sum of each primary local existing logical digit in the primary local prefix sum sequence to sort the global data.

Article A29. The method of article A26, where the primary sorting sequence includes a plurality of primary local sorting sequences, where the primary local sorting sequences include positions of primary local existing logical digits;
dividing the primary global prefix sum sequence into a plurality of primary local prefix sum sequences, where the primary local prefix sum sequences include local prefix sums of primary local existing logical digits; and
through a plurality of processing cores, storing local data to which each primary local existing logical digit belongs in corresponding positions of the primary local sorting sequences respectively in parallel according to a local prefix sum of each primary local existing logical digit in the primary local prefix sum sequences to sort the global data.

Article A30. The method of any one of articles A26-A29, further including:
each time the global data to which each primary global existing logical digit belongs or local data to which each primary local existing logical digit belongs is stored in the corresponding position of the sorting sequence, subtracting one from the prefix sum of the primary global statistical count or the local prefix sum.

Article A31. The method of any one of articles A17-A30, where at least two of the processing cores store primary sorting local data used as part of the primary sorting global data, and iteratively re-sorting the primary sorting global data according to the secondary existing global logical digits of the primary sorting global data to form the re-sorting global data includes:
creating a secondary local digit statistical sequence, where the secondary local digit statistical sequence includes: secondary local general logical digits to which secondary local existing logical digits belong in the primary sorting local data, and primary local statistical counts of the secondary general logical digits in the secondary local existing logical digits;
forming a secondary global digit statistical sequence according to the secondary local digit statistical sequence, where the secondary global digit statistical sequence includes: secondary global general logical digits to which secondary global existing logical digits belong in the primary sorting local data, and secondary global statistical counts of the secondary global general logical digits in the secondary global existing logical digits;
determining a prefix sum of the secondary global statistical counts of the secondary global general logical digits in the secondary global digit statistical sequence to form a secondary global prefix sum sequence; and
determining a secondary position of the primary sorting global data in the storage space according to the secondary global prefix sum sequence to re-sort the primary sorting global data.

Article A32. The method of any one of articles A17-A31, further including: sorting existing global logical digits of another level of the global data in response to a case where all existing global logical digits of the same level in the global data are identical.

Article A33. The method of any one of articles A17-A32, where the global data is decimal data; in some embodiments, when the decimal data includes a negative number, all bits of a binary representation of the negative decimal data are inverted; and when the decimal data further includes a positive number, a sign bit of a binary representation of the positive decimal data is inverted.

Article A34. The method of any one of articles A17-A32, where when the global data is a floating point number, the floating point number is converted to a hexadecimal representation to sort the hexadecimal representation.

Article A35. The method of article A34, where when the floating point number includes a negative number, all bits of a hexadecimal representation of the negative number are inverted; and when the floating point number further includes a positive number, a sign bit of a hexadecimal representation of the positive number is inverted.

Article A36. An electronic device, including:
one or a plurality of processors; and
a memory, on which a computer-executable instruction is stored, where when the computer-executable instruction is run by the one or the plurality of processors, the electronic device performs the method of any one of articles A1-A35.

Article A37. A computer-readable storage medium, including a computer-executable instruction, where when the computer-executable instruction is executed by one or a plurality of processors, the method of any one of articles A1-A35 is performed.

Article B1. A method for sorting data in a single-core processor, including:
creating a digit statistical sequence, where the digit statistical sequence includes: general logical digits to which existing logical digits of the same level belong in the data, and statistical counts of the general logical digits in the existing logical digits of the same level in the data;
determining a prefix sum of statistical counts of the general logical digits in the digit statistical sequence to form a prefix sum sequence; and
determining a position of the data in storage space according to the prefix sum sequence to sort the data.

Article B2. The method of article B1, where the statistical counts are sorted in an ascending or descending order of the general logical digits.

Article B3. The method of articles B1 or article B2, where determining the prefix sum of the statistical counts of the general logical digits in the digit statistical sequence to form the prefix sum sequence includes:
adding a statistical count of each logical digit in the digit statistical sequence to all preceding statistical counts to obtain the prefix sum; and
storing the prefix sum in a corresponding position of each logical digit to form the prefix sum sequence.

Article B4. The method of any one of articles B1-B3, where determining the position of the data in the storage space according to the prefix sum sequence to sort the data includes:
creating a sorting sequence; and
storing data to which each logical digit belongs in a corresponding position of the sorting sequence according to a prefix sum of a statistical count corresponding to each existing logical digit in the prefix sum sequence to sort the data.

Article B5. The method of or article B4, further including:
each time the data to which each logical digit belongs is stored in the corresponding position of the sorting sequence, subtracting one from the prefix sum of the statistical count.

Article B6. The method of any one of articles B1-B5, where the data is decimal data; in some embodiments, when the decimal data includes a negative number, all bits of a binary representation of the negative decimal data are inverted; and when the decimal data further includes a positive number, a sign bit of a binary representation of the positive decimal data is inverted.

Article B7. The method of any one of articles B1-B5, where when the data is a floating point number, the floating point number is converted to a hexadecimal representation to sort the hexadecimal representation.

Article B8. The method of article B7, where when the floating point number includes a negative number, all bits of a hexadecimal representation of the negative number are inverted; and when the floating point number further includes a positive number, a sign bit of a hexadecimal representation of the positive number is inverted.

Article B9. A method for sorting data in a single-core processor, including: sorting the data according to primary existing logical digits of the data to form primary sorting data; and iteratively re-sorting the primary sorting data according to secondary existing logical digits of the primary sorting data to form re-sorting data.

Article B10. The method of article B9, where sorting the data according to the primary existing logical digits of the data to form the primary sorting data includes:
creating a primary digit statistical sequence, where the primary digit statistical sequence includes: primary general logical digits to which primary existing logical digits belong in the data, and primary statistical counts of the primary general logical digits in the primary existing logical digits of the data;
determining a prefix sum of statistical counts of the primary general logical digits in the primary digit statistical sequence to form a primary prefix sum sequence; and
determining a primary position of the data in storage space according to the primary prefix sum sequence to sort the data to form the primary sorting data.

Article B11. The method of article B10, where the primary statistical counts are sorted in an ascending or descending order of the primary general logical digits.

Article B12. The method of article B10 or article B11, where determining the prefix sum of the primary statistical counts of the primary general logical digits in the primary digit statistical sequence to form the primary prefix sum sequence includes:
adding a primary statistical count of each primary digit in the primary digit statistical sequence to all preceding primary statistical counts to obtain the prefix sum; and
storing the prefix sum in a corresponding primary position of each primary digit to form the primary prefix sum sequence.

Article B13. The method of any one of articles B10-B12, where determining the primary position of the data in the storage space according to the primary prefix sum sequence to sort the data to form the primary sorting data includes:
creating a primary sorting sequence; and
storing data to which each primary digit belongs in a corresponding position of the primary sorting sequence according to a prefix sum of a primary statistical count corresponding to each primary existing logical digit in the primary prefix sum sequence to sort the data to form the primary sorting data.

Article B14. The method of article B13, further including:
each time the data to which each primary digit belongs is stored in the corresponding position of the primary sorting sequence, subtracting one from the prefix sum of the primary statistical count.

Article B15. The method of any one of articles B10-B15, where iteratively re-sorting the primary sorting data according to the secondary existing logical digits of the primary sorting data to form the re-sorting data includes:
creating a secondary digit statistical sequence, where the secondary digit statistical sequence includes: secondary general logical digits to which secondary existing logical digits belong in the primary sorting data, and secondary statistical counts of the secondary general logical digits in the secondary existing logical digits of the primary sorting data;
determining a prefix sum of the secondary general logical digits in the secondary digit statistical sequence to form a secondary prefix sum sequence; and
determining a secondary position of the primary sorting data in storage space according to the secondary prefix sum sequence to re-sort the primary sorting data to form the re-sorting data.

Article B16. The method of any one of articles B9-B15, further including: sorting existing logical digits of another level in response to a case where existing logical digits of the same level in the existing logical digits are identical.

Article B17. The method of any one of articles B1-B16, where the data is decimal data; in some embodiments, when the decimal data includes a negative number, all bits of a binary representation of the negative decimal data are inverted; and when the decimal data further includes a positive number, a sign bit of a binary representation of the positive decimal data is inverted.

Article B18. The method of any one of articles B1-B16, where when the data is a floating point number, the floating point number is converted to a hexadecimal representation to sort the hexadecimal representation.

Article B19. The method of article B18, where when the floating point number includes a negative number, all bits of a hexadecimal representation of the negative number are inverted; and when the floating point number further includes a positive number, a sign bit of a hexadecimal representation of the positive number is inverted.

Article B20. The method of any one of articles B1-B19, where the single-core processor supports a vector operation.

Article B21. An electronic device, including:
one or a plurality of processors; and
a memory, on which a computer-executable instruction is stored, where when the computer-executable instruction is run by the one or the plurality of processors, the electronic device performs the method of any one of articles B1-B20.

Article B22. A computer-readable storage medium, including a computer-executable instruction, where when the computer-executable instruction is executed by one or a plurality of processors, the method of any one of articles B1-B20 is performed.

1: A method for sorting global data in a multi-core processor, wherein
the multi-core processor comprises a plurality of processing cores, at least two of the processing cores store local data used as part of the global data, the method comprising:
creating a local digit statistical sequence, wherein the local digit statistical sequence comprises: local general logical digits to which local existing logical digits of the same level belong in the local data, and local statistical counts of the local general logical digits in the local existing logical digits of the same level in the local data;
forming a global digit statistical sequence according to the local digit statistical sequence, wherein the global digit statistical sequence comprises: global general logical digits to which global existing logical digits of the same level belong in the global data, and global statistical counts of the global general logical digits in the global existing logical digits of the same level in the global data;
determining a prefix sum of the global statistical counts of the global general logical digits in the global digit statistical sequence to form a global prefix sum sequence; and
determining a position of the global data in storage space according to the global prefix sum sequence to sort the global data.

2: The method of claim 1, wherein the local statistical counts are sorted in an ascending or descending order of the local general logical digits.

3: The method of claim 1, wherein the forming of t he global digit statistical sequence according to the local digit statistical sequence comprises:
adding a plurality of local digit statistical sequences accordingly to form the global digit statistical sequence.

4: The method of claim 1, wherein the plurality of processing cores are connected to shared memories and communicate through the shared memories, thereby forming the global digit statistical sequence according to the local digit statistical sequence.

5: The method of claim 1, wherein the plurality of processing cores are divided into a plurality of processing core groups, in each processing core group, processing cores of the same group are connected to a shared memory, and the plurality of processing core groups communicate through respective shared memories, thereby forming the global digit statistical sequence according to the local digit statistical sequence.

6: The method of claim 5, wherein the multi-core processor comprises a global memory, and the plurality of processing cores are directly connected to the global memory, or the plurality of processing cores are indirectly connected to the global memory through the shared memories, thereby forming the global digit statistical sequence according to the local digit statistical sequence.

7: The method of claim 1, wherein the determining of the prefix sum of the global statistical counts of the global general logical digits in the global digit statistical sequence to form the global prefix sum sequence comprises:
adding the global statistical counts of the global general logical digits in the global digit statistical sequence to all preceding global statistical counts to obtain a global prefix sum; and
storing the global prefix sum in a corresponding position of each digit in the global general logical digits to form the global prefix sum sequence.

8: The method of claim 1, wherein determining of the position of the global data in the storage space according to the global prefix sum sequence to sort the global data comprises:
creating a sorting sequence; and
storing global data to which each global existing logical digit belongs in a corresponding position of the sorting sequence according to a prefix sum of a global statistical count corresponding to each global existing logical digit in the global prefix sum sequence to sort the global data.

9: The method of claim 8, wherein the sorting sequence is a global sorting sequence, wherein the global sorting sequence comprises positions of global existing logical digits; and
through a processing core, storing the global data to which each global existing logical digit belongs in the corresponding position of the sorting sequence according to the prefix sum of the global statistical count corresponding to each global existing logical digit in the global prefix sum sequence to sort the global data.

10: The method of claim 8, wherein the sorting sequence is a global sorting sequence, wherein the global sorting sequence comprises positions of global existing logical digits;
dividing the global prefix sum sequence into a plurality of local prefix sum sequences, wherein the local prefix sum sequences comprise local prefix sums of local existing logical digits of the same level; and
through a plurality of processing cores, storing local data to which each local existing logical digit belongs in a corresponding position of the global sorting sequence in parallel according to a local prefix sum of each local existing logical digit of the same level in the local prefix sum sequence to sort the global data.

11: The method of claim 8, wherein the sorting sequence comprises a plurality of local sorting sequences, wherein the local sorting sequences comprise positions of local existing logical digits;
dividing the global prefix sum sequence into a plurality of local prefix sum sequences, wherein the local prefix sum sequences comprise local prefix sums of local existing logical digits of the same level; and
through a plurality of processing cores, storing local data to which each local existing logical digit belongs in corresponding positions of the local sorting sequences respectively in parallel according to a local prefix sum of each local existing logical digit of the same level in the local prefix sum sequences to sort the global data.

12: The method of claim 8, further comprising:
each time the global data to which each global existing logical digit belongs or local data to which each local existing logical digit belongs is stored in the corresponding position of the sorting sequence, subtracting one from the prefix sum of the global statistical count or the local prefix sum.

13: The method of claim 8, further comprising:
dividing sorted global data into a plurality of groups of sorted local data; and
storing the plurality of groups of sorted local data in the plurality of processing cores respectively.

14: The method of claim 1, wherein the global data is decimal data; in some embodiments, when the decimal data comprises a negative number, all bits of a binary representation of the negative decimal data are inverted; and when the decimal data further comprises a positive number, a sign bit of a binary representation of the positive decimal data is inverted.

15: The method of claim 1, wherein, when the global data is a floating point number, the floating point number is converted to a hexadecimal representation to sort the hexadecimal representation.

16: The method of claim 15, wherein, when the floating point number comprises a negative number, all bits of a hexadecimal representation of the negative number are inverted; and when the floating point number further comprises a positive number, a sign bit of a hexadecimal representation of the positive number is inverted.

17: A method for sorting global data in a multi-core processor, wherein the multi-core processor comprises a plurality of processing cores, at least two of the processing cores store local data used as part of the global data, the method comprising:
sorting the global data according to primary existing global logical digits of the global data to form primary sorting global data; and
iteratively re-sorting the primary sorting global data according to secondary existing global logical digits of the primary sorting global data to form re-sorting global data.

18: The method of claim 17, wherein the sorting of the global data according to the primary existing global logical digits of the global data to form the primary sorting global data comprises:
creating a primary local digit statistical sequence, wherein the primary local digit statistical sequence comprises: primary local general logical digits to which primary local existing logical digits belong in the local data, and primary local statistical counts of the primary local general logical digits in the primary local existing logical digits;
forming a primary global digit statistical sequence according to the primary local digit statistical sequence, wherein the primary global digit statistical sequence comprises: primary global general logical digits to which primary global existing logical digits belong in the global data, and primary global statistical counts of the primary global general logical digits in the primary global existing logical digits;
determining a prefix sum of the primary global statistical counts of the primary global general logical digits in the primary global digit statistical sequence to form a primary global prefix sum sequence; and
determining a primary position of the global data in storage space according to the primary global prefix sum sequence to sort the global data.

19: The method of claim 17, further comprising:
dividing the primary sorting global data into a plurality of groups of primary local sorting data; and
storing the plurality of groups of primary local sorting data in the plurality of processing cores respectively.

20-35. (canceled)

36: An electronic device, comprising:
one or a plurality of processors; and
a memory, on which a computer-executable instruction is stored, wherein when the computer-executable instruction is run by the one or the plurality of processors, the electronic device performs the method of claim 1.

37. (canceled)
